(19) United States
(12) Patent Application Publication
(10) Pub. No.: US 2023/0325736 A1
(43) Pub. Date: Oct. 12, 2023

(54) SYSTEM AND METHOD FOR ALLOCATING MULTI-FUNCTIONAL RESOURCES

(71) Applicant: Nice Ltd., Ra'anana (IL)

(72) Inventors: Eyal SEGAL, Ramat Gan (IL); Noam KAPLAN, Tel-Aviv (IL); Gennadi LEMBERSKY, Haifa (IL)

(73) Assignee: Nice Ltd., Ra'anana (IL)

(21) Appl. No.: 18/325,347

(22) Filed: May 30, 2023

Related U.S. Application Data
(63) Continuation-in-part of application No. 17/694,784, filed on Mar. 15, 2022.

(51) Int. Cl. G06Q 10/0631; G06Q 10/0639

(52) U.S. Cl. CPC G06Q 10/06312; G06Q 10/063112; G06Q 10/06395

(57) ABSTRACT

A computerized system and method for allocating multi-functional or multi-feature resources (which may handle multiple functions or tasks, e.g., simultaneously) for a plurality of time intervals, including: transforming an initial allocation matrix (which may associate each resource with a single function, task, or feature - and may not address simultaneous handling of tasks or task types by the resources) into an updated allocation matrix, where the updated allocation matrix includes a plurality of feature matrices describing different multi-feature resources to be allocated; predicting, using a machine learning (ML) model, expected service metrics for the updated allocation matrix; and providing a final allocation matrix based on the expected service metrics. Embodiments may perform iterative calculations and/or transformations of data to improve allocation matrices and provide a final allocation matrix for which predicted service metrics correspond to required or optimal service metrics.

### RELATED APPLICATION DATA

The present application is a continuation-in-part of prior U.S. Application 17/694,784 filed on Mar. 15, 2022, incorporated by reference herein in its entirety.

### FIELD OF THE INVENTION

The present invention relates generally to resource optimization, in particular to using combined search and predictive algorithms to schedule allocation of resources.

### BACKGROUND OF THE INVENTION

Contemporary systems exist to handle the problem of resource allocation, such as computer system resource allocation or generating staffing requirements (e.g. how many agents are needed in each time interval) in a voice only (e.g. communications between people using only voice) environment. The setting of voice calls only has been the main environment in which contact centers (also known as call centers) have operated. In the voice only setting, agents can handle only one contact at a certain time and will be available to handle another call only once the current call has been completed. The voice setting is in fact a sub-problem of generating staffing requirements under the constraint of maximum concurrency equal to 1.

However, the constraint of maximum concurrency equal to 1 may be relaxed in the digital contact center, where, for example, agents are expected to be able to concurrently handle a plurality of communications over multiple channels such as web chat, email, and short message service (SMS). This major shift in the way work is distributed and handled has great implications on both the number (and cost) of agents required at the contact center, as well as on the quality of service provided to the contacting customers.

Existing systems are not designed to handle this new way of work, accounting for the need of an agent to divide their full attention across multiple customers and channels at a time, and therefore a new approach is needed to address the problem of generating staffing requirements for contact center agents in the digital contact center, handling multiple concurrent contacts over a multitude of different digital channels, such as chat, email, WhatsApp, etc., as well as voice.

Many companies provide products that generate staffing requirements. These solutions, as well as the solutions provided by NICE Ltd., all rely on two main methods to approximate the needed staffing for a certain interval: the Erlang C formula, and simulations. These two methods have both been around for many decades, and while many improvements and adjustments have been made to them, in essence they are both bounded to the limitations of using average handling time (AHT) to approximate service level. While using these two solutions and relying on AHT has proved useful for many years, as seen before, in the digital and concurrent world these are not enough.

Both existing solutions lack the ability to capture the complexity of digital mediums, as well as the intricacies of different methods of using them, employed by different users. While in the past communications were limited to the voice medium, today a variety of channels are available. This new diversity in communication channels has opened the door to many new forms and methods of communication such as asynchronous communications, elevations between channels (e.g. a customer initially sending a chat message, but being later elevated to a voice call, perhaps because of the complexity of their problem), and many more. As a result, different users are using these channels in very different ways, resulting in very different meaning for the same volumes, for different tenants (e.g. the occupying company of a call centre). When trying to select an optimal concurrency value for different tenants, this approach makes it very hard to generalize a recommendation to all users.

### SUMMARY OF THE INVENTION

A computerized system and method may automatically allocate resources to handle a plurality of tasks within a given time interval, or a plurality of time intervals. Embodiments of the invention may provide resource allocation candidates for which expected service metrics may be predicted using a machine learning model. An allocation candidate for which predicted service metrics correspond to required (e.g., predefined) service metrics may be provided as a final allocation candidate.

Embodiments of the invention may allocate multi-functional or multi-feature resources, which may be resources capable of simultaneously handling multiple functions or tasks.

A computerized system comprising a processor may transform an initial allocation matrix (which may, e.g., associate each resource with a single function, task, or feature - and may not address simultaneous handling of tasks or task types by the resources) into an updated allocation matrix, where the updated allocation matrix includes a plurality of feature matrices describing different multi-feature resources to be allocated; predict, using a machine learning (ML) model, expected service metrics for the updated allocation matrix; and provide a final allocation matrix based on the expected service metrics. Embodiments may further perform iterative calculations and/or transformations of data and/or data formats to improve allocation matrices and provide a final allocation matrix for which predicted service metrics correspond to required or optimal service metrics.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a block diagram of a system according to an embodiment of the present invention;

FIG. 2 is a block diagram of a method according to an embodiment of the present invention;

FIG. 3 is a block diagram showing a focused view of elements of FIG. 2;

FIG. 4 is a block diagram showing a focused view of elements of FIG. 3;

FIG. 5 is a flow diagram of a method according to an embodiment of the invention;

FIG. 6 is a diagram showing the structure of a neural network according to an embodiment of the present invention;

FIG. 7 is a diagram showing the structure of a neural network according to an embodiment of the present invention;

FIG. 8 is a block diagram of a system according to an embodiment of the present invention;

FIG. 9 is a representation of a graphical user interface according to an embodiment of the present invention;

FIG. 10 illustrates an example allocation candidate modified search algorithm according to some embodiments of the invention;

FIG. 11 shows an example process of transforming an initial allocation matrix into an updated allocation matrix according to some embodiments of the invention;

FIG. 12 shows an example visualization of an example multi-skill agent distribution which may be used in some embodiments of the invention;

FIG. 13 illustrates an example procedure of updating a muti-skill allocation matrix according to some embodiments of the invention;

FIG. 14 is a high-level block diagram showing a first example machine learning model architecture according to some embodiments of the invention;

FIG. 15 is a high-level block diagram showing a second example machine learning model architecture according to some embodiments of the invention;

FIG. 16 is a diagram showing a second example structure of a neural network according to some embodiments of the invention;

FIG. 17 illustrates a second example of a system according to some embodiments of the present invention;

FIG. 18 is a second example graphical user interface according to an example embodiment of the invention; and

FIG. 19 shows an example method for allocating resources according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Embodiments of the invention relate to a novel method for approximating the quality of service provided by a set of agents for a specific time interval or time period. To predict while accounting for the great variability in service times, as well as their dependency on a myriad of different time dependent variables, a machine learning algorithm, e.g. a deep learning neural network, is trained on the data in a novel fashion. Furthermore, a novel search approach is applied over possible inputs to the trained model, leveraging the trained model as a means for selecting the optimal staffing requirement, so that the net staffing will be as low as possible while providing the required service levels. In some embodiments this may improve the technologies of machine learning. This algorithm differs from other existing methods in that it utilizes a resource unavailable until now, the historical data on workload, agents, and the contact center for service metric prediction.

Embodiments of the invention may staff or allocate multi-functional or multi-feature resources, which may be resources capable of simultaneously handling multiple functions or tasks. Embodiments may transform an initial allocation candidate, which may describe resources such that each resource may be associated with one task or task type, into an updated allocation candidate associating resources with multiple tasks or task types that may be performed, e.g., in parallel, for a given time interval or timeframe. Embodiments may provide a final or optimal allocation candidate based on service metrics predictions by a machine learning model, where generated or predicated metrics for a final candidate may correspond or match required service metrics.

As used herein, “Call Center” may refer to a centralized office used for receiving or transmitting a large volume of interactions which may include, for example, enquiries by telephone. An inbound call center may be operated by a company (e.g. a tenant) to administer incoming product or service support or information enquiries from consumers.

As used herein, “Contact Center” may refer to a call center which handles other types of communications other than voice telephone calls, for example, email, message chat, SMS, etc. Reference to call center should be taken to be applicable to contact center.

As used herein, an “Agent” may be a contact center employee that answers incoming contacts, handles customer requests and so on.

As used herein, a “Customer” may be the end user of a contact center. They may be customers of the company that require some kind of service or support.

As used herein, “Work Force Management (WFM)” may refer to an integrated set of processes that a company uses to optimize the productivity of its employees. WFM involves effectively forecasting labor requirements and creating and managing staff schedules to accomplish a particular task on a day-to-day and hour-to-hour basis.

As used herein, “Staffing Requirements” may refer to the required amount of personnel (e.g. agents) needed at a contact center to handle expected contacts in accordance with quality-of-service metrics.

As used herein, “Workload” may refer to the overall amount of work to be handled or being received. In the example of a call center, workload may be work arriving at the call center. In other examples, e.g. where resources are computer hardware or software resources, workload may be measured differently. Workload may be calculated as a factor of volumes, average handling time, and customer latency, as well as others. Workload may be broken down into one or more skills, e.g. a workload may be given which is broken down or otherwise characterized by a workload for a first skill and a workload for a second skill.

As used herein, “Volume” may refer to a number of contacts coming into a contact center. Workload and volume may also relate, for example, to contact center occupancy - which may measure or quantify how far a contact center is or should be from working at its full capacity (e.g., from a maximal utilization or exhaustion of resources), and thus to various service metrics and targets as further described herein.

As used herein, “Average Handling Time (AHT)” may refer to the average time from start to finish of a customer interaction. AHT may be an important factor in understanding how much work (e.g. workload) the contact center is handling/will handle. As used herein, “Customer Latency” may refer to a measure describing how long on average a customer takes to respond to an agent after the agent has replied. This measure may be an important factor in quantifying the workload in the digital contact center.

As used herein, “Service Metrics” may refer to key performance indicators (KPIs) designed to evaluate the experience of the contacting customers and the quality of service provided to them, in terms of work force and agent availability. These KPIs can include average speed of answer, service level and customer latency amongst others. When the contact center is understaffed, service metrics may be lower than defined, and when over staffed, higher. Each user may select the service metrics that are important for their contact center and may define values based on their preferences. These may be referred to as “Service Targets” or “Required Service Metrics” in the sense that they are a required target to be achieved by any allocation assignment.

As used herein, “Wait Time” or “Average Speed of Answer (ASA)” may refer to a service metric used for voice calls detailing how long customers waited until their call was picked up by an agent.

As used herein, “Service Level Agreement (SLA)” may refer to a service metric, similar to the above ASA. A service level agreement may allow a user to define a percentage of users answered within a selected time frame, e.g. 30 minutes. The more general “service level” or “level of service” may at times be used herein to refer to a quality of service as measured by one or more service metrics, which may include SLA.

As used herein, “Abandoned percentage” may refer to a service metric quantifying the possibility that as ASA grows, more customers get tired of waiting and hang up whilst waiting for an agent.

As used herein, “Skills” may refer to a method of compartmentalizing agent training and specialty into different useful categories, e.g. technical support, financial inquiries and so on. Skills may also be used as a means of representing different channels of communication such as voice, chat etc., where tech_support_voice could be one skill and tech_support_chat could be another.

As used herein, “Under/Over staffing” may refer to situations when the contact center is not working effectively, and money is being wasted. When overstaffed, customers are served beyond the defined service metrics, agents are not fully utilized, and money is wasted. When understaffed, customers are served poorly in terms of agent availability, and thus other important processes in the contact center cannot happen.

As used herein, “Forecasting Period” may refer to data generated for a selected period, often starting from the present or from the end time of the current schedule.

As used herein, “Concurrency” may refer to the fact that in the digital contact center agents serving customers over digital channels will often find themselves working on more than one contact at a time. Working concurrently on multiple contacts can both improve agent utilization as well as degrade the service provided to the contacting customer. Concurrency is often defined by the user creating the staffing requirements as a fixed value for the maximum amount of contacts an agent should work on.

As used herein, “Dynamic Concurrency” may refer to the phenomenon that as the workload, intensity and complexity of a specific work item varies, as well as the overall topics of customer requests changing, so too does the agent’s ability to handle different levels of concurrency. The present approach presents a search over a machine learning model that evaluates these parameters and de facto returns an implicit concurrency level.

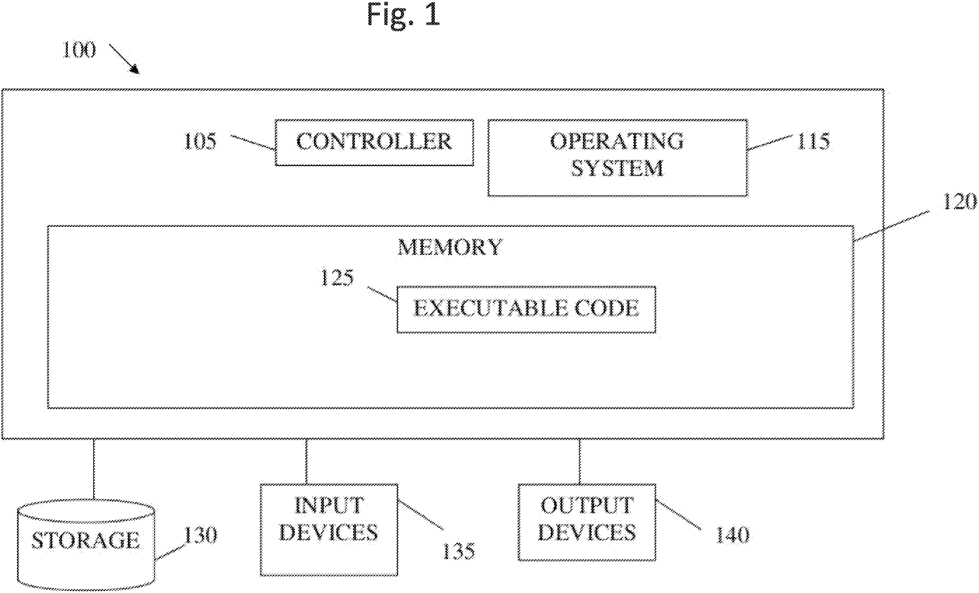

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or data such as low-level action data, output data, etc.

Executable code 125 may be any application, program, process, task, or script. Executable code 125 may be executed by controller 105 possibly under control of operating system 115. For example, executable code 125 may be or execute one or more applications performing methods as disclosed herein, such as a machine learning model, or a process providing input to a machine learning model. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

Embodiments of the invention may involve training a machine learning model. The machine learning model may be a deep learning model inspired by but differing from the structure of an organic human brain, otherwise known as a neural network. Where it is understood that deep learning models are a subset of machine learning models, further reference herein to machine learning should be understood as referring also to deep learning models.

A machine learning model may be trained according to some embodiments of the invention by receiving as input at least one of: volumes over different skills and channels; average handling time (AHT); customer latency; and number of agents assigned and corresponding skill composition. These data may represent historical data over past periods or intervals, where the data for each interval is a training sample. For each past interval the model may receive for example the actual workload (volumes, AHT, customer latency) as well as groups or sets of agents, each associated with various skills. The output of the model may be the predicted or expected service metrics measured for this historical interval, such as service level, ASA, chat latency and /or general metrics for different channels. In an embodiment where the resource is another resource, for example a computer resource, the past interval training data may be loads or usage for computer resources.

Some embodiments of the invention may train the machine learning model as essentially a regression model with multiple inputs and outputs. After the model is trained it may be utilized by a search algorithm. In some embodiments of the invention, the model may be for example a deep learning or neural network based model as further described herein.

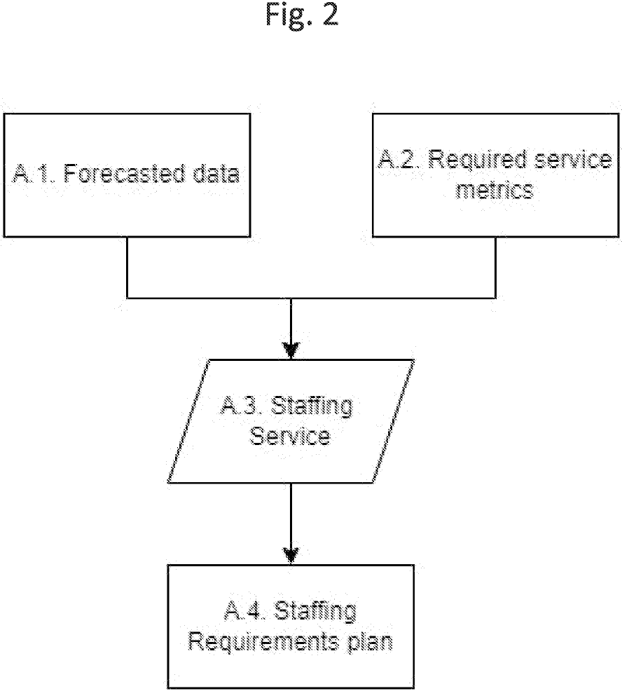

With reference to FIG. 2, embodiments of the invention provide a method for providing staffing schedules responsive to predicted requirements.

In the following diagrams, parallelograms represent processes, rectangles represent data and rhombuses represent decisions based on parameters and data. Parameters are represented as data as well.

Embodiments of the invention may include providing/receiving forecast data (block A.1). Forecasted data may take the format or shape of (| intervals | X | skills | X |features|), for example a vector or matrix with a number of entries/cells corresponding to a product between the number of intervals, skills and features. Forecasted data may be a time series depicting the workload relevant to the resource; e.g. the workload the call center will need to handle. This multi-variate time series may include features such as volume (number of contacts across different channels), AHT and average customer latency (average time elapsed between agent response and customer replying). The workload may be divided across different communications channels, and these communication channels may be non-voice communication channels (e.g. not a spoken telephone call) chosen, for example, from a list including any of: short message service, email, web chat, integrated chat, or social media message. Web chat and/or integrated chat may refer to a communication functionality coded into or otherwise available (e.g. as a widget) as part of a website or app, for example available on a customer service section of a company website. The forecasted data/workload may be broken down by or divided across one or more skills characterizing the resources, e.g. in a call/contact centre the workload may be broken down across agents having skills in refund requests, general queries, and customer complaints. The above features are examples and forecasted data is not limited to these or these alone. Features may be predicted for every interval during the forecasting period, and for each skill separately.

Embodiments of the invention may include providing/receiving at least one required staffing service metric value (block A.2). Required staffing service metrics may take the shape of (|skills| X |service metrics|). Required staffing service metrics may represent the minimal service level a user could accept. A user may set values for all variables. Possible metrics may include, for example, SLA (e.g., 80% of calls should be answered within 30 seconds) and chat latency (e.g., agents take 60 seconds to respond to a chat message on average).

Accordingly, a method and/or system according to embodiments of the invention may include as a first step receiving a forecasted workload and at least one required service metric value for each of the plurality of time intervals.

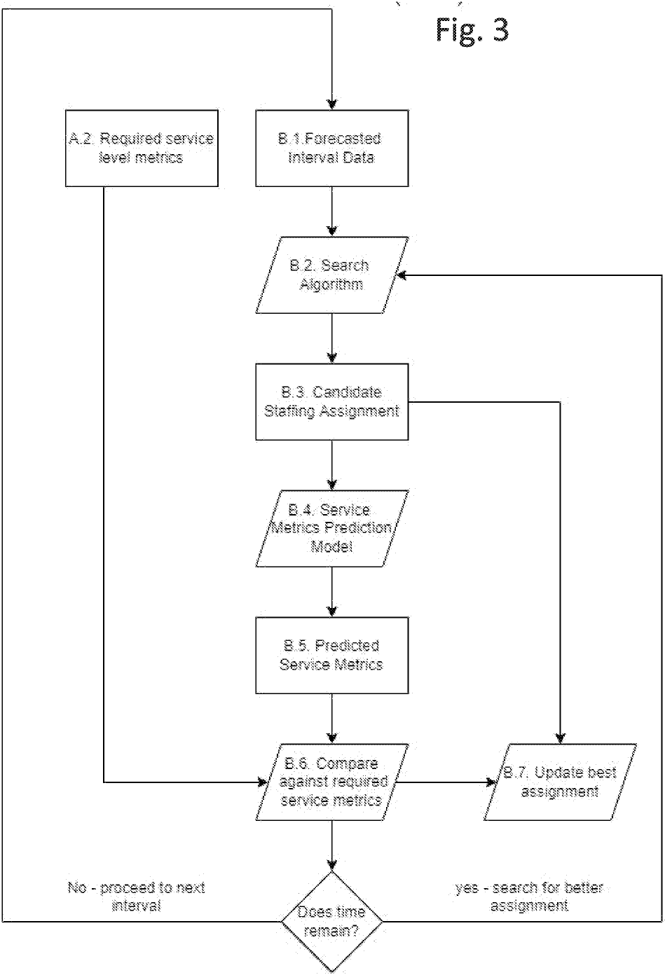

FIG. 3 represents a focused view of the staffing service and requirements plan (blocks AX.3 and AXx.4) shown in FIG. 2, and describes an algorithm according to embodiments of the invention for creating staffing requirements for a single interval.

Forecasted interval data (block BX.1) may take the shape (|skills| X |features|) and may represent a single time element from the forecasted data of AX.1. Forecasted interval data is the workload that needs to be handled during a particular interval. For each interval, an iterative process may be performed, as will be described herein further below.

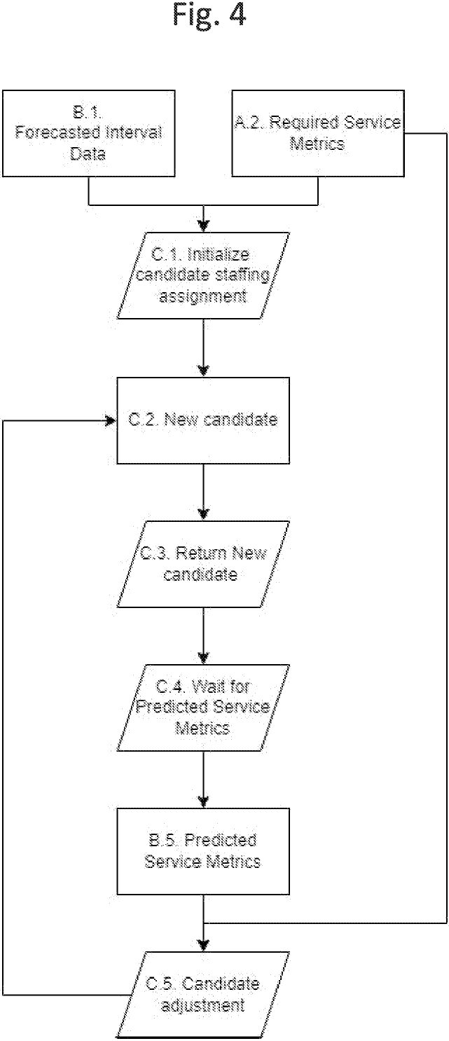

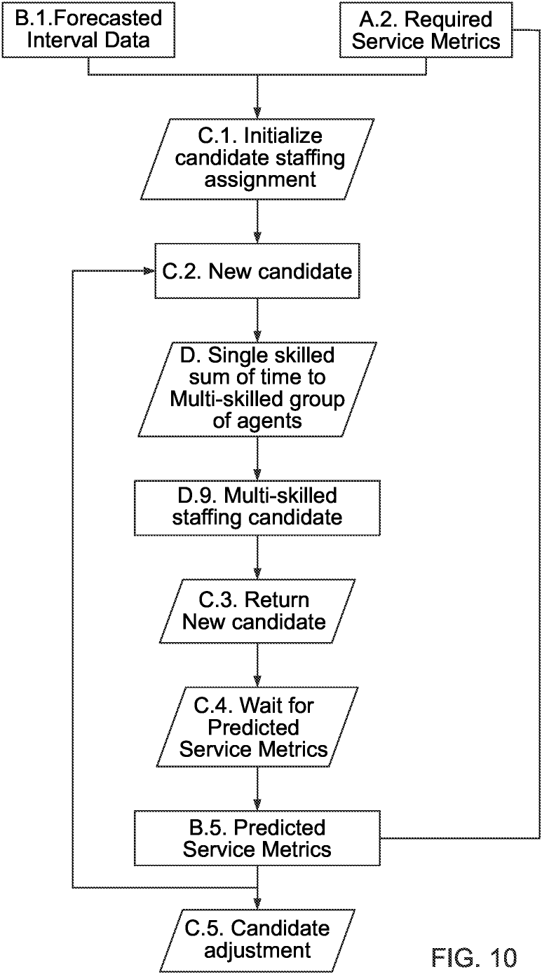

A search algorithm (block BX.2) may suggest an initial/candidate staffing or assignment requirement (block B.3) for a specific interval: for example, a method and/or system according to embodiments of the invention may include, for each interval, applying a search algorithm to identify an initial allocation assignment. An example search algorithm is described in detail below with respect to FIG. 4 (see, however, additional FIGS. 10-13 and related discussion). The initial staffing/allocation assignment may have for example the format or shape (|skills|) and may represent a count vector of how many agents are suggested for each skill. A candidate staffing assignment, after one or more iterative updates as will be described further herein below, may become a single item/element in the time series of A.4 representing the full staffing requirements plan for all intervals. In other embodiments a search algorithm may be over assignments of other resources, such as computer resources.

A service metric value expected to be achieved by the initial staffing requirement (block B.3) handling the forecasted workload (block BXX.1) may then be predicted using a machine learning service level prediction model (block BXX.4), for example by inputting the initial allocation assignment to a machine learning algorithm, wherein the machine learning algorithm has been previously trained on historic data of a plurality of past intervals. Embodiments of the invention relate to a novel approach for using neural networks to predict the service metrics which may be provided in an interval by a certain staffing for a particular workload. Inputs to this model (e.g. the neural network) may include the forecasted workload (block B.1), and a (at least initial) staffing assignment (block B.3), and could be extended to include any other relevant input. For example, the model may receive as input a forecasted workload (e.g. a workload for future intervals, which may be broken down by skill) and a required service metric value. The machine learning model may provide a prediction: the output of this trained algorithm may be service metric predictions (e.g. a particular value) for each skill (block B.5). For example, a method and/or system according to embodiments of the invention may include predicting, for each at least one required service metric, by the machine learning algorithm, an expected service metric value provided by the initial allocation assignment.

Predicted service metrics (block B.5) as output by the service metrics prediction model (block B.4) (e.g. “expected” service metrics expected to be achieved by the assignment) may have the shape (|skills| X |service metrics|) and may represent predicted values for each service metric specified by a user. These values may represent the fit of the suggested staffing to the workload during the specific interval. For example, if the staffing assignment suggested as a candidate for the interval is insufficient to handle a certain workload, then the predicted values will be low.

The predicted service metric value(s) for the interval across all skills and service metrics as received by the machine learning service metrics prediction model may then be compared (block B.6) to the at least one required service metric value(s) (block A.2) as provided by the user. A difference between the required service metrics (block A.2) and the predicted service metrics (block B.5) may be calculated, for example by an element wise application of the subtraction operator (-). The result of this calculation may be a matrix of the same shape as in both blocks A.2 and B.5. Cells in the resulting matrix with a positive value may imply a specific skill is overstaffed. Cells with a negative value may imply a certain skill is under staffed. Cells with a value close to zero imply that the skill is staffed correctly. These values may be used to evaluate the staffing in each skill, as well as the overall fitness of the assignment.

After comparison, the candidate staffing requirement most fitting the required service metrics may be updated (block B.7), for example, by adjusting the initial allocation assignment based on a difference between the expected service metric value and the corresponding at least one required service metric value. If the current candidate staffing assignment is predicted to produce a better outcome (measured in terms of service metrics) than the previously suggested best candidate staffing assignment, then the best staffing assignment may be updated. Comparison may result in a scalar number representing how good a staffing assignment is. This scalar may be calculated as a weighted average of the difference/distance between the required and predicted service levels weighted by the volume of each skill, so the grade is consistent with the service level experienced by most users. The best candidate staffing assignment may be the assignment to supply the best service level at the lowest cost.

If time remains, the algorithm may iterate again, using the difference as expressed/captured by the correction factor between the required and the predicted service levels as a means of generating an improved candidate staffing assignment which, after several repetitions, may make the predicted service metrics converge to the required service level metrics. The optimal candidate for the interval may be set as the staffing requirements for this interval. If time does not remain, or if an optimal assignment (for example, within an acceptable predetermined distance range or + tolerance of the required service level metrics) has been found for the interval, the algorithm may accept the candidate staffing requirement for the current interval and may proceed to the next interval. For example, the search algorithm may adjust an initial allocation assignment based on a difference between the expected service metric value and the corresponding at least one required service metric value and may iteratively repeat the previous applying, inputting, predicting, and adjusting operations until one of: the expected service metric value predicted for an adjusted allocation assignment is within a predetermined distance of the corresponding at least one required service metric value for the interval; or a predetermined time has elapsed. A predetermined distance may be a positive scalar value characterizing a “closeness” of the expected service metric value to the target service metric value. For example, a predetermined distance may be selected as within 0.3 of a required service metric value of 10, and thus an assignment which is predicted to achieve a corresponding service metric value of 6 is not within the predetermined distance (e.g. |10 — 6| = 4 >> 0.3): however, an updated assignment which achieves a value of 10.2 for that assignment is within the predetermined distance (|10 — 10.21 = 0.2 < 0.3).

A staffing requirements plan may be output (block A.4), which may have the shape (|intervals| X |skills|), and which may, for each interval, represent how many agents are needed in each skill. In other words, the staffing requirments plan is the sequence of interval requirements generated for all intervals within the forecasted period. The staffing requirements plan may be used to create a schedule of actual agents. For example, a method and/or system according to embodiments of the invention may include generating, from the iteratively adjusted allocation assignments, an allocation assignment plan for the plurality of time intervals.

FIG. 4 shows a focused view of the search algorithm shown in block BX.2 of FIG. 3. The search algorithm may suggest the next candidate/potential staffing assignment based on the difference between the required service metrics and the predicted service metrics for the previous assignment. Using forecasted interval data (block B.1) and the required service metrics (block A.2) an initial staffing assignment may be generated (block C.1). A staffing assignment may have the shape (|skills|), and a positive entry in each cell may represent the number of agents per each skill that may be required for the interval. Such allocation shape or format may also be referred to herein as a single-sum-of-time format, due to the fact that a plurality of agents are summed or binned into a single entry to describe the sum of time spent by all agents assigned to a single skill within a given time interval. A staffing assignment may also be referred to as a staffing option, or as an allocation assignment or matrix. In order to begin the search, the search algorithm may require a starting point, e.g. an initial staffing assignment. The initial staffing assignment could be generated by different methods, for example, random sampling, Erlang C formulas, simulations, etc. The initial staffing assignment may also be generated by a workload calculation by taking the total time needed (e.g. Volume*AHT) and dividing by the total time of one of the intervals: for example, for a volume of two calls that take 7.5 minutes each, the total is 2*7.5 = 15, then dividing by the length of a 15 minute interval, a workload of 1 agent may be obtained, e.g. 1 agent is required to handle the workload (given two calls of 15 minutes, or one call of 30 minutes, a workload of two agents is obtained). This initial staffing assignment, generated by any of the described means, may then be iteratively improved, as will be described herein.

The search algorithm may then enter a loop, and the new candidate (block C.2) may be returned (block C.3) to the calling procedure specified in FIG. 3. As with the initial staffing assignment, the new candidate may have the shape (|skills|), and a positive entry in each cell may represent the number of agents suggested for the interval. The newly suggested candidate staffing assignment is returned to the staffing service (A.3), shown in FIG. 3 as candidate staffing assignment (block B.3).

The search algorithm may now wait (block C.4) for the predicted service metric value(s) (block B.5) expected to be achieved for the staffing assignment. The search algorithm may receive either a stop signal on which the search will terminate, or the predicted service metric value(s) for the suggested/candidate assignment. The predicted/expected service metrics may have the shape (|skills| X |service metrics|). Predicted service metrics may be generated for each of the candidate staffing options suggested by the search algorithm and may be passed back to the search algorithm if time remains (see the bottom of FIG. 3).

Once received, the search algorithm may adjust the initial allocation assignment. For example, the search algorithm may use the predicted service metrics (block B.5) together with the required service metrics (block A.2) to calculate an adjustment factor and adjust (block C.5) the previous candidate. For example, a method and/or system according to embodiments of the invention may include adjusting, by the search algorithm, the initial allocation assignment based on a difference between the expected service metric value and the corresponding at least one required service metric value. The adjustment factor may be a vector and may have the shape (|skills|), and may represent how to adjust the staffing assignment to produce a candidate for the next iteration. Each cell in the adjustment vector may contain values used to increase (greater than 1) or decrease (between 0-1) the previous staffing assignment. The adjustment factor may result in the number of agents needed for a specific skill being increased if service metrics have not been met in a previous iteration, and decreased when service metrics have been exceeded (which may not be efficient or cost effective).

For each metric used to evaluate a skill, a ratio may be calculated. For metrics where a lower score is better, such as ASA (wait time until answer), a correction ratio may be defined as follows:

$$c o r r e c t i o n r a t i o = \frac{\left(1 + P r e d i c t e d M e t r i c V a l u e\right)}{\left(1 + R e q u i r e d M e t r i c V a l u e\right)}$$

wherein a predicted (service) metric value may also be referred to as an expected (service) metric value. Similarly, a required (service) metric value may also be referred to as a target (service) metric value.

For example, having an ASA value higher than required implies that the contact center is understaffed for this skill. The correction ratio in this case will be larger than 1. In the opposite case, the correction will be lower than one. The correction value may be calculated for each skill, where skills with more than one metric may average the correction ratio across service metrics. The resulting vector will have an entry for each skill with a value larger than 1 for skills where more agents are required, and a value between 0-1 if the number of agents in the skill should be reduced.

For metrics where a higher value is better, such as SLA, the correction ratio will simply be the inverse correction ratio, i.e. correction ratio⁻¹. Thus, a vector adjustment factor may include scalar correction ratios for each skill.

To calculate a new candidate for the next interval, an element-wise product may be performed between the previous candidate vector and the adjustment factor vector. The result of this product may be an increase or decrease in the suggested workforce, at the skill level, for the new candidate staffing assignment.

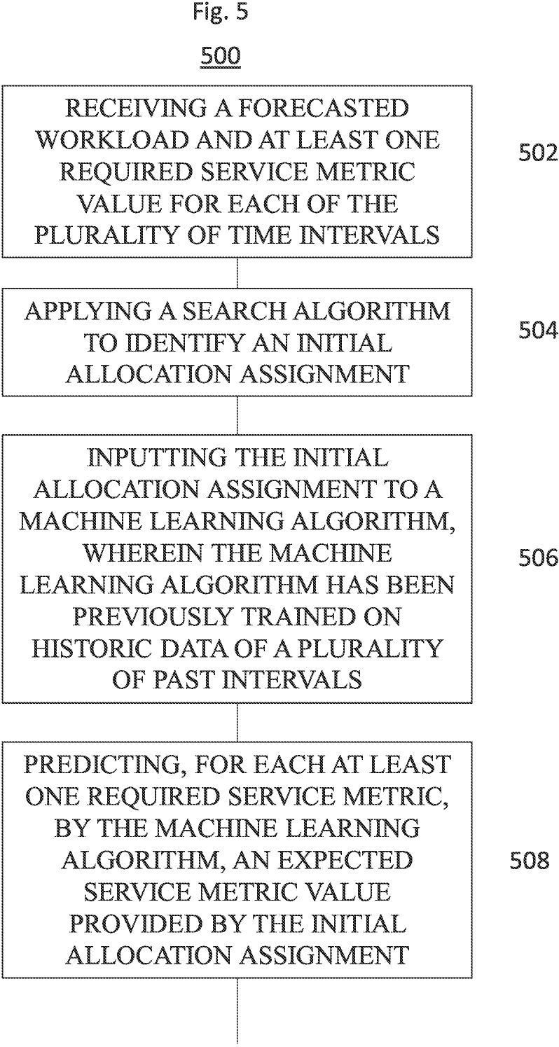

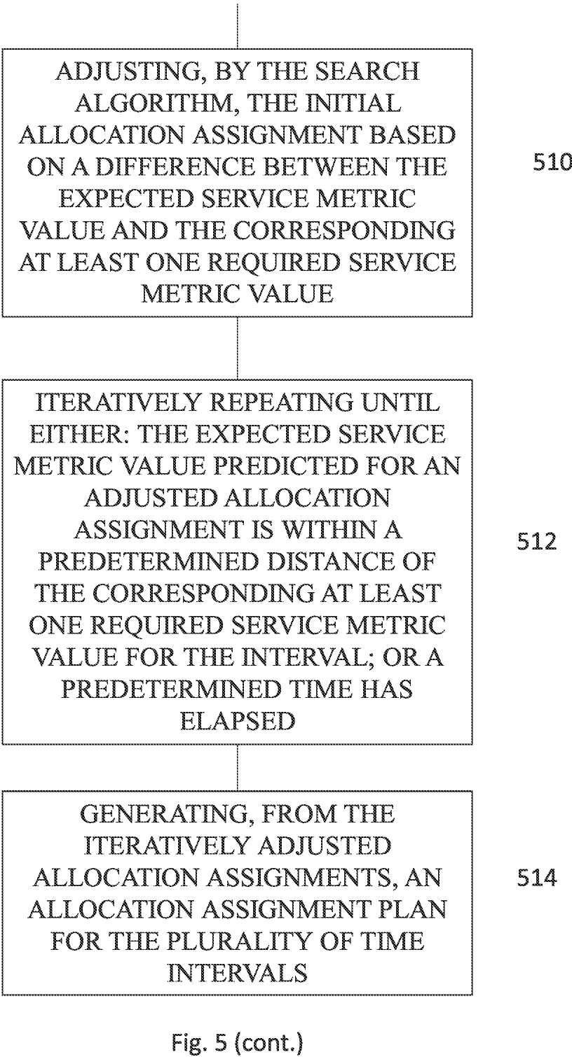

FIG. 5 shows a method 500 for allocating resources for a plurality of given time periods or intervals. While in one example embodiment resources may be workers such as contact center agents having desired skills, resources may also be any resource for which provisioning over a series of time intervals (next 20 minutes, next hour, next day, coming week, etc.) is required, for example: computer servers; data storage volumes; and power sources in a power grid. Resources may be classified by skills. For example, where the resources are workers such as agents in a contact center, skills may include technical expertise and financial expertise. Where the resource is a power source for example, the classifying skills (or attributes) may relate to a renewable status, a power output etc.

Method 500 may include receiving (502) a forecasted workload and at least one required service metric value for each of the plurality of time intervals. A forecasted workload may be forecasted by means known in the art, for example by simulation. A required service metric value may be a quantification of a level of service to be met based on one or more considerations such as demand, cost, and practicality.

Method 500 may include, for each period interval, applying (504) a search algorithm to identify an initial allocation assignment for that period or interval. The search algorithm may be a search algorithm as described by block B.2 and in FIG. 4, or another suitable search method. The initial allocation assignment may for example be a candidate staffing option. The initial allocation assignment may be selected based on random sampling, or may be a more informed selection based on Erlang C formulas, workload calculation, or simulation. In examples with other resources such as computer resources, allocation assignments may be relevant to assignment of those other resources.

Method 500 may include, for each interval, inputting (506) the initial allocation assignment to a machine learning algorithm. The machine learning algorithm may have been previously trained on historic data of a plurality of past intervals. The machine learning algorithm may be a service metrics prediction model as described by block B.4.

Method 500 may include, for each interval, predicting (508), for each at least one required service metric, by the machine learning algorithm, an expected service metric value provided by the initial allocation assignment. For example, based on training data of historic intervals, the machine learning algorithm may predict that an initial allocation assignment will achieve a particular value for a particular service metric.

Method 500 may include, for each interval, adjusting (510), by the search algorithm, the initial allocation assignment based on a difference between the expected service metric value and the corresponding at least one required service metric value.

Method 500 may include, for each interval, iteratively repeating (512) until for example the expected service metric value predicted for an adjusted allocation assignment is within a predetermined distance of the corresponding at least one required service metric value for the interval; or a predetermined time has elapsed.

Method 500 may optionally include generating (514), from the iteratively adjusted allocation assignments, an allocation assignment plan for the plurality of time intervals. For example, a schedule or rotation may be generated detailing how the resources are to be distributed across the intervals to achieve an optimal allocation for the forecasted workload.

An embodiment of the invention may also relate to a method for optimizing workforce management plans in environments concurrently handling a plurality of voice and non-voice communications channels for a plurality of workforce skills, in a given time interval. The method may include receiving a forecasted workload and a required level of service. A level of service may, for example, include one or more service metrics, and as such a level of service may include a required service level within the meaning of service level agreement (SLA), i.e. a predetermined percentage of customers answered in a predetermined time period. The method may include searching to identify an initial staffing assignment. The method may include predicting, by a machine learning algorithm, a predicted service level expected for the initial staffing assignment. The machine learning algorithm may have been previously trained on historic data of handling communications in past intervals. The method may further include calculating a difference between the predicted level of service and the required level of service. The method may further include iteratively updating the initial staffing assignment based on the calculated difference until either: the level of service predicted for the updated staffing assignment by the machine learning algorithm is within a predetermined distance of the required level of service for the interval; or a predetermined time has elapsed.

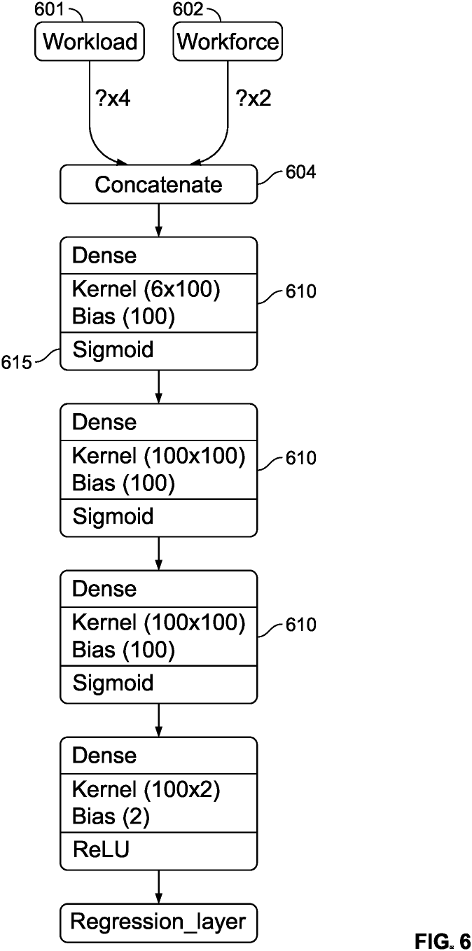

With reference now to FIG. 6, a machine learning algorithm employed by embodiments of the invention is discussed in detail. Embodiments of the invention suggest a novel method of predicting the service level using machine (or deep) learning predictors trained on historical data to produce accurate and personalized service metric predictions. According to embodiments of the invention, a model is trained to predict the service metrics in a particular interval based on the forecasted workload and the available agents, as well as other features that might include time of day, agent proficiency, and so on.

By analysing historical data intervals, three main elements may be calculated:
Workload: the workload which came into the contact center during a specific interval.
Actual staffing: The actual staffing may be derived from the workforce working at the contact center at the time.
Service metrics: for each skill, depending on the channel, different service metrics are calculated. ASA for example would be calculated as the average time waited by customers on a voice skill until an agent answered the call.

Workload and actual staffing may serve as the main inputs to the machine learning model. The model may then be trained on historical intervals to predict the service metrics defined for each skill depending on the workload and the available personnel.

FIG. 6 describes an example machine learning or deep learning model architecture 600 according to some embodiments of the invention, worked through for a two skill scenario. The model may have an input layer, which may receive for example the workload 601 and actual staffing (workforce) 602 for each skill, e.g. the expected volume, average handling time and number of agents for each skill. These inputs may be concatenated (604).

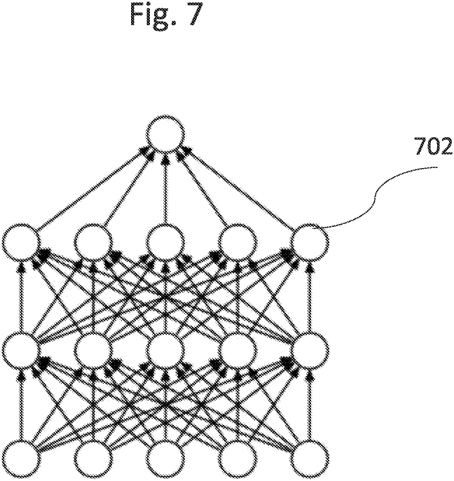

The input may be propagated through to a sequence of standard neural network dense layers 610, each followed by a sigmoid activation 615. Dense layers (also known as fully connected layers) are connected to each other, see FIG. 7. Activation functions may be used as switches determining the flow of information within the model. Activation functions may also be called non-linearities, as they allow stacked linear layers to model complicated non-linear problems. A sigmoid function is a bounded, differentiable, real function that is defined for all real input values and has a non-negative derivative at each point and exactly one inflection point. The function is common in deep learning architectures as it transforms all input values to values between 0 and 1. The sigmoid function is described by the expression:

$$S \left(x\right) = \frac{1}{1 + {e}^{- x}} = \frac{{e}^{x}}{{e}^{x} + 1}$$

The final layer may be a dense layer with a ReLU activation, trained to predict the service metric of each skill. The rectified linear unit (ReLU) activation function is a piecewise linear function that outputs the input directly if it is positive, otherwise it will output zero. It has become the default activation function for many types of neural networks because a model that uses it is easier to train and often achieves better performance. The ReLU activation function is defined as:

$$f \left(x\right) = \left\{\begin{matrix}x & \text{if} x > 0 , \\ 0 & \text{otherwise} \text{.}\end{matrix}\right)$$

The output of model 600 may be, for each skill, value predictions of the different service metrics, providing a predicted/expected service metric value(s) which can be leveraged by a search algorithm according to embodiments of the invention to identify an optimal staffing assignment.

As an example, for a certain past interval with two skills, a volume of 100 and 200 interactions (e.g. calls) for each skill respectively, an AHT of 240 and 180 seconds and a staffing of 10 agents and 100 agents respectively, the input vector may be [100, 200, 240, 180, 10, 100].

Given that for the first skill, 10 agents is far from enough agents to serve properly, it could be expected that the ASA metric will have a very high (e.g. bad) value. Since 100 agents is much more than needed for skill two, it could be expected that the ASA value will be very low. The output vector in this case could be [90, 8], meaning customers waited 90 seconds on average until being answered by an agent for skill 1, and 8 seconds for skill 2.

Below are example simulation results for a two skill scenario, using ASA as a service metric. All results are reported in pairs, one value for each skill. The algorithm is run on one time interval, and the output of the process will be the staffing requirements for this interval. In the scenario simulated below, the contact center will have to handle a volume of 100, 200 interactions (calls) for each skill respectively, and meet an average handling time (AHT) of 240, 180 seconds respectively. The initial candidate (block C.1, FIG. 4) can be seen on line 4 of the simulation printout. The initial candidate may be chosen by random sampling and allowed to converge by repeated iterations, or a more informed starting point can be chosen based on Erlang C formulas or simulation. Every iteration the model is used to generate a prediction of the service metric for each skill. Using the target and predicted metric value (ASA) for each skill, a correction factor is calculated for each skill, with the number of agents by which to increase or decrease each skill. A new candidate is created using the previous candidate and the adjustment factor. The candidate with predicted service metrics closest to the required service metrics will be used as the staffing requirement for this interval.

Table 1 below depicts example simulation results for a two skill scenario, using ASA as a service metric.

TABLE 1

Target service metric ASA: [30, 30]
Call volume: [100 200]
Call handling time (aht): [240 180]
Initial candidate: [24. 68.]
Iteration 0
Predicted service metric (ASA): [46. 26.]
adjustment: [37.49 -7.57]
Candidate: [24. 68.]
New candidate: [61.49 60.43]
Iteration 5
Predicted service metric (ASA): [25. 37.]
adjustment: [-1.09 11.03]
Candidate: [42.73 53.48]
New candidate: [41.64 64.51]
Iteration 10
Predicted service metric (ASA): [26. 27.]
adjustment: [-0.4 -0.57]
Candidate: [40.2 65.37]
New candidate: [39.8 64.8]
Iteration 15
Predicted service metric (ASA): [31. 28.]
adjustment: [2.5 -0.17]
Candidate: [ 67.49]
New candidate: [ 67.31]
Iteration 20
Predicted service metric (ASA): [31. 27.]
adjustment: [2.04 -0.23]
Candidate: [41.44 65.55]
New candidate: [43.48 65.32]
Iteration 25
Predicted service metric (ASA): [29. 28.]
adjustment: [-0.04 -0.1 ]
Candidate: [44.38 63.67]
New candidate: [44.35 63.57]
Iteration 30
Predicted service metric (ASA): [24. 25.]
adjustment: [-0.26 -0.3 ]
Candidate: [45.56 65.13]
New candidate: [45.3 64.83]
Iteration 35
Predicted service metric (ASA): [25. 27.]
adjustment: [-0.17 -0.15]
Candidate: [44.01 63.59]
New candidate: [43.84 63.44]
Iteration 40
Predicted service metric (ASA): [27. 17.]
adjustment: [-0.09 -0.66]
Candidate: [43.1 64.75]
New candidate: [43.01 64.09]
Iteration 45
Predicted service metric (ASA): [31. 20.]
adjustment: [ 0.99 -0.45]
Candidate: [43.46 63.19]
New candidate: [44.44 62.74]
Iteration 50
Predicted service metric (ASA): [19. 25.]
adjustment: [-0.29 -0.17]
Candidate: [43.74 63.7 ]
New candidate: [43.45 63.53]
Iteration 55
Predicted service metric (ASA): [28. 26.]
adjustment: [-0.05 -0.14]
Candidate: [42.8 63.04]
New candidate: [42.75 62.91]
Iteration 60
Predicted service metric (ASA): [21. 25.]
adjustment: [-0.21 -0.15]
Candidate: [43.29 63.54]
New candidate: [43.08 63.39]

FIG. 7 shows an example of a neural network architecture, as may be used by embodiments of the invention. Individual neurons or nodes 702 may be connected to other neurons, and neurons may be organized into layers.

The following table (Table 2) summarizes example data used by embodiments of the invention.

TABLE 2

| | | |
|---|---|---|
| Block | Shape | Description |
| A.1 Forecasted Data | (\|intervals\| X \|skills\| X \|features\|) | Time series depicting the workload the call center will need to handle. This multi-variate time series may include features such as volume (number of contacts across different channels), AHT, and average customer latency. |
| A.2 Required staffing metrics | (\|skills\| X \|service metrics\|) | The minimal service level a user could accept. User sets values for all variables. Possible metrics may include SLA (e.g., 80% of calls should be answered within 30 seconds) and chat latency (e.g., 80% of chat messages responded to within 60 seconds). |
| A.4 Staffing Requirements Plan | (\|intervals\| x \|skills\|) | For each interval, how many agents are needed in each skill. The staffing requirements plan will be used to create a schedule of actual agents. |
| B.1 Forecasted Interval Data | (\|skills\| X \|features\|) | A single time element from A.1. Forecasted data. This is the workload that needs to be handled during the interval. |
| B.3 Candidate Staffing Assignment | (\|skills\|) | A count vector of how many agents are suggested for each skill. Might become a single time element from A.4. |
| B.5 Predicted Service Metrics | (\|skills\| X \|service metrics\|). | Outputs of B.4. Predicted values for each service metric specified by user. |
| C.2 New Candidate | (\|skills\|) | A vector with positive entries in each cell representing the number of agents suggested in the candidate staffing for the interval. |
| C.5 Candidate Adjustment | (\|skills\|) | A new candidate with increased personnel at skills that were understaffed and decreased personnel for skills that were overstaffed. |

Embodiments of the invention may take the output of an algorithm (e.g. staffing requirements for each skill for interval in the given period) and may use this output as an input for a scheduling system, which may assign specific agents for the shift. Embodiments of the invention may perform this action automatically, without human intervention.

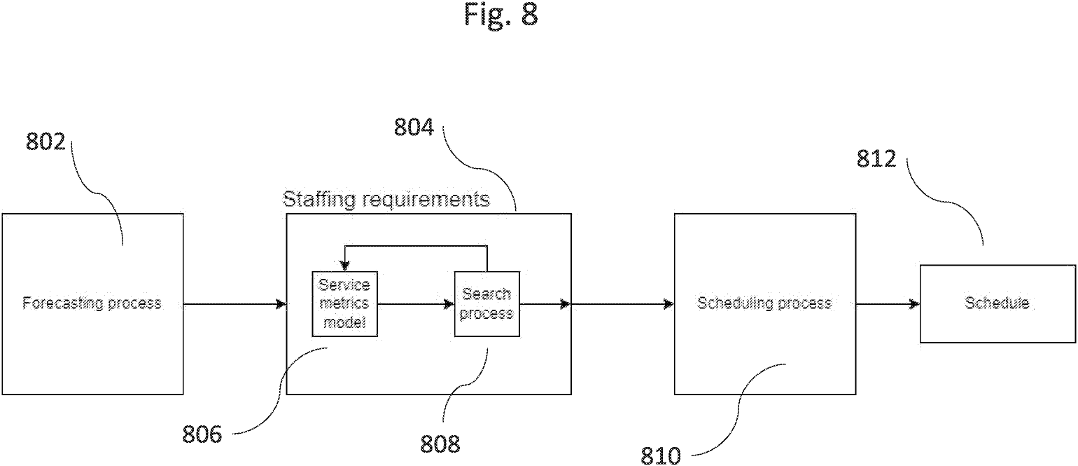

FIG. 8 demonstrates how a model according to embodiments of the invention is a working element of a wider process for creating staffing requirements. For example, a forecasting process 802, as may be known in the art, may generate forecasted data such as an expected workload for a given interval. Staffing requirements 804 may then be generated in accordance with embodiments of the present invention, for example by a trained service metrics model 806 (such as a machine learning model herein described) operating in iterative conjunction with a search process 808 (such as a search algorithm herein described). Generated staffing requirements may then be passed to a scheduling process 810, which may automatically produce a schedule 812.

Further, embodiments of the invention may be used to identify gaps in staffing as and when they are generated. Gaps in staffing may be due to unplanned events during the day, and embodiments of the invention may suggest proactive actions such as postponing a break, canceling training, etc.

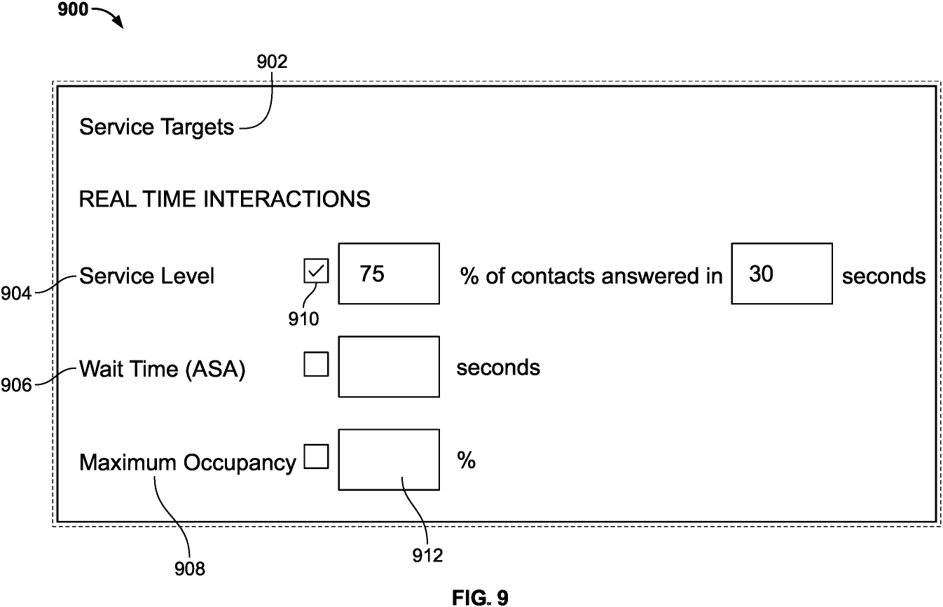

FIG. 9 shows an example of a graphic user interface (GUI) 900 according to embodiments of the invention. Service Targets 902 may refer to a KPI designed to evaluate the experience of the contacting customers and the quality of service provided to them, in terms of work force and agent availability. Service level (SLA) 904, a common service metric, may allow the user to define the percentage of users answered within a selected time frame, e.g. 80% of customers answered within 20 minutes. Wait Time 906 (ASA) is a common service metric used for voice calls detailing how long customers waited until their call was picked up by an agent. Maximum Occupancy 908 may refer to a value meant to specify how far off the contact center should be from working at its full capacity. Using an interface 900 such as that shown by FIG. 9, a user may be able to set the desired target service metric values. User interface 900 may include checkboxes 910, which may allow a user to toggle or otherwise select which service metrics they wish to optimize. User interface 900 may include input fields 912, which may allow a user to enter a value (e.g. a numeric value) representing the desired service metric. User interface 900 may allow a user to change a duration of a time period, for example an interval, or a timeframe with respect to SLA. User interface 900 may include dropdowns or fields with which to change a time period, for example a dropdown list expressing units of seconds, minutes, hours, etc.

A system according to embodiments of the invention may take inputs from GUI 900 and conduct a search over the predictions of the neural network to find an optimal staffing candidate.

Embodiments of the invention may improve the technologies of computer automation, big data analysis, and computer use and automation analysis by using specific algorithms to analyze large pools of data, a task which is impossible, in a practical sense, for a person to carry out. Embodiments of the invention may improve existing scheduling technologies by rapidly and automatically analyzing previously unutilized pools of historic data. Integration of embodiments of the invention into a contact centre environment may improve automated call-dialing technology. Embodiments of the invention may improve the technology of “smart” chats, which use contextual word recognition to automatically reply to client queries.

It should be emphasized that while some embodiments of the invention are discussed or considered herein as relating to allocation of human agents or resources, e.g., in a contact center environment — different embodiments of the invention may generally be used for resource allocation tasks in a great variety of technological environments. For example, some embodiments of the invention may be applied, e.g., to the allocation of computational resources (including, but not limited to, processing and/or memory and/or storage units) in a data center or high-performance computing cluster environments. Thus, discussions relating to, e.g., contact center environments should be considered non-limiting, and anthropomorphic terms such as “agent”, “skill” and the like, should be considered as being applied to analogous entities, e.g., terms such as, e.g., “resource”, “feature”, “function” and the like.

In addition to or apart from the various protocols and procedures considered herein, some embodiments of the invention may be used to generate allocation assignments or candidates that may describe multi-skill agents (or, more generally, multi-functional or multi-feature resources).

Multi-skill agents (or multi-functional/multi-feature resources) as referred to herein may be agents (e.g., resources) associated with multiple different skills (e.g., features), as opposed to ones associated with a single skill which may be considered by some of the embodiments described herein. For example, allocation candidates such as described, e.g., in block C.1. may associate an agent with a single skill or task type per time interval, which may imply that a given agent may be allocated to perform a single task or task type for the time interval considered. Multi-skill agents, on the other hand, may be assumed to be capable of using more than one skill within a given time interval for which an allocation assignment or candidate is calculated. For example, a multi-skill agent in a contact center may be an agent capable of, or trained for simultaneously handling both phone-call and text-chat channels, or handling both sales and customer support tasks — while a single-skill agent may be one being capable of handling only one of those channels or tasks types. In another example, a multi-feature processing unit in a high-performance cluster may, for example, be assigned to simultaneously handle both “heavy” (or CPU or I/O intensive) and “regular” (less CPU or I/O intensive) jobs among a plurality of jobs submitted by different cluster tenants within a given time interval, while a single-feature processing unit may be assigned to handle only regular, less intensive jobs. One skilled in the art may consider additional or alternative examples of multi-feature vs. single-feature resources which may relate to, inter alia, various computer infrastructure resources managed by cloud computing platforms, servers handling network traffic over a communication network, and the like.

Multi-skill agents may require different representations, e.g., in allocation candidates. In addition, allocating or assigning multi-skill agents by some embodiments of the invention may require a modified, dedicated allocation candidate search algorithm (different from, e.g., the one outlined in FIG. 4) and/or a different machine learning model architecture for its execution.

Embodiments of the invention may convert or transform an initial allocation matrix (which may also be referred to herein as allocation or staffing candidate) into an updated allocation matrix (or updated candidate), which may account for the allocation of multi-skill agents. In some embodiments, the initial allocation candidate may be the one produced in block C.1. of FIG. 4 — which may be a matrix in a single-sum-of-time (SSOT) format.

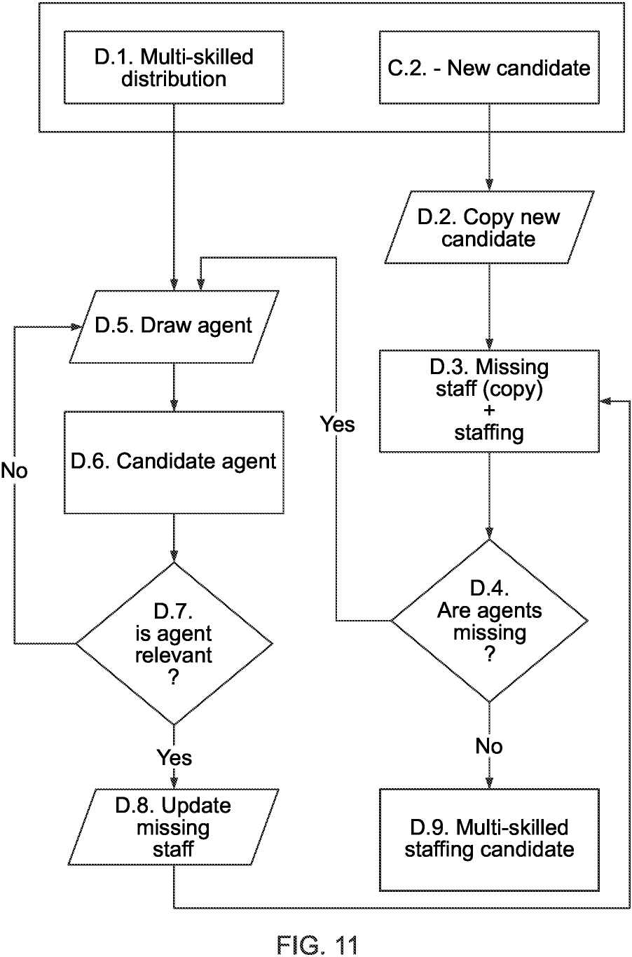

FIG. 10 illustrates an example modified allocation candidate search algorithm according to some embodiments of the invention. In such example algorithm, an additional process or subprocess may be added to, e.g., the reference algorithm in FIG. 4, as may be illustrated in blocks D, D.9. in FIG. 10. The added process, in which an initial allocation candidate may transformed into an updated allocation candidate, e.g., based on (a) assembling a group of multi-skill agents which may be missing from the initial candidate (block D) and (b) update the allocation candidate based on the assembled group of multi-skill agents (block D.9.), may generally be used to account for multi-skill agents as further described herein. In some embodiments, blocks D-D.9. may generally correspond or refer to a process, e.g., such as further described with reference to FIG. 11 herein. It should be noted, however, that additional or alternative processes or subprocess may be, e.g., implemented in allocation candidate search algorithm workflows such as the one outlined in FIG. 10 — and that alternative workflows and/or implementations may be used in different embodiments of the invention.

FIG. 11 shows an example process of transforming an initial allocation matrix into an updated allocation matrix according to some embodiments of the invention.

In block D.1., embodiments may receive input data for the matrix, such as resource descriptions (e.g. computer resources, agent descriptions, etc.). For example, a process may input a database of agents (or resources) which may include a multi-skill agent distribution (or multi-feature resource distribution) and include a plurality of skill or feature groups, or sets of skills which may be used by agents as part of their work or task schedule. The multi-skill agent distribution may thus include a vector of format or shape (|skill groups|). The required dataset or skill distribution may be included, for example, in a database of resources which may be generated, stored or calculated, e.g., by a WFM system including data records describing all agents in the contact center (or, for example, similar or equivalent records used by a dedicated component in a cloud computing platform) — although other protocols for obtaining a skill distribution may be used in different embodiments of the invention.

One example multi-skill agent distribution may, e.g., have a matrix form as outlined in Table 3:

TABLE 3

| Skill Groups | ... | {A, B} | {A,C} | {A,B,C} | ... |
|---|---|---|---|---|---|
| n | ... | 1 | 0 | 2 | ... |
| % | ... | 2 | 0 | 4 | ... |

where, e.g., A=sales, B=tech _support, and C=complaints; where “n” describes the number of agents having belonging to the skill group in the same column (e.g., the distribution describes one agent of the skill group {A, B}, and two agents of the skill group {A, B, C}); and where % describes the relative weight or percentage of agents belonging to a given skill group among all agents considered in the distribution (in the case of Table 3, there may be 50 agents in the entire distribution, and thus each agent amounts to 2%). Alternative multi-skill agent distribution formats may be used in different embodiments.

Embodiments may extract feature or skill groups from a multi-skill agent distribution to which at least one agent belongs. For instance, {A, B} and {A, C} may be extracted from the example distribution provided in Table 3. Embodiments may count the number of agents belonging to each skill group (which may be, e.g., the number of agents having all skills included in a given skill group, and them alone) and calculate a relative weight for each skill group, which may be, for example, the percentage of that skill group from all contact center agents. In some embodiments, such relative weight may be included in the distribution used as an input in block D.1.

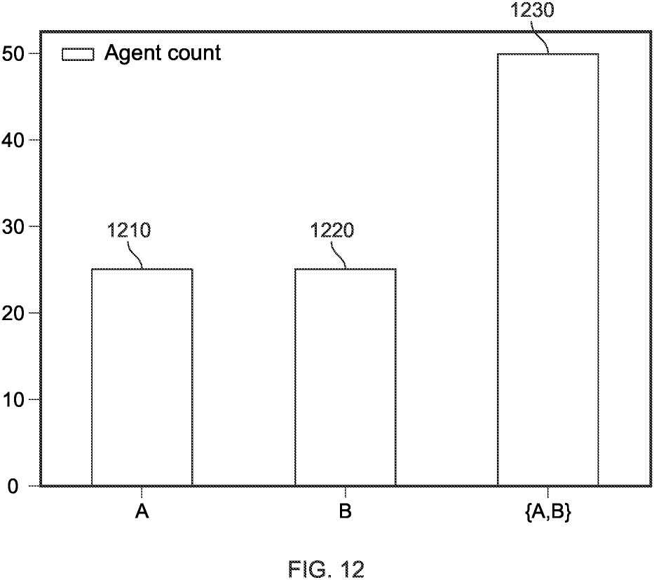

FIG. 12 shows an example visualization of an example multi-skill agent distribution which may be used in some embodiments of the invention. In this example, three skill groups 1210, 1220, 1230 — each including a corresponding relative agent count are shown. In this example, agents possessing only skill A, and thus belonging to skill group 1210, amount to 25% of all agents considered. Agents possessing only skill B and belonging to skill group 1220 amount to a similar percentage. Agents possessing both skills A and B and belonging to skill group 1230 amount to the remining 50% of all agents.

Turning back to FIG. 11, embodiments may receive an initial or new allocation matrix such as, e.g., the candidate generated in block C.2 (see also, e.g., discussion referring to FIG. 4 herein) and having a shape of (|skills |), and convert or transform it into a multi-feature or multi-skill allocation matrix (or MSK matrix for short) or multi-skill staffing candidate format, e.g., according to the subsequent steps considered herein.

Embodiments may copy the initial allocation matrix from step C.2. into a dedicated, new (e.g., empty) data structure, which may be referred to herein as the MSK matrix or updated allocation matrix (block D.2). The MSK matrix may include, apart from the copy of the initial candidate, a plurality of blank spaces which may subsequently be populated with multi-skill agent vector or matrix representations (which may also be referred to herein as “agent/resource representation models”, “skill/feature matrices”, or simply “models”, for short). The MSK matrix may be updated in an iterative manner (blocks D.3.-D.8.) to populate empty spaces, e.g., such that required service metrics are better satisfied, e.g., as described herein with reference to FIGS. 3-5. Following the copying of the initial candidate received in block C.2., and throughout subsequent iterations of the procedure under consideration (blocks D.3.-D.8.), blank spaces in the MSK matrix may be written and/or updated to include, e.g., an additional two-component submatrix of shape of (|skills|, |agents|x|skills|) which may be calculated by embodiments of the invention. The first component of the shape |skills| may be referred to as the “missing staff” (MST) vector and may describe, at each iteration of the process under consideration, how many agents may still be missing for satisfying the required service metrics (e.g., as provided in block B.5. of FIGS. 3-4; see also discussion referring to FIG. 5); The second component of the shape |agents|x|skills| may include a plurality of agent models which may be added to the allocation candidate at each iteration, and may include or describe the skills of each newly-added agent. Alternative formats may be used for the missing staff vector and/or agent models in different embodiments of the invention.

An example MSK matrix which may be provided in block D.3. is shown in Table 4:

TABLE 4

| | Initial Candidate | MST Vector | Multi-Skill Agent Models | | | |
|---|---|---|---|---|---|---|
| | | | [blank] | [blank] | [blank] | ... |
| Skill A | 15 | +2 | [blank] | [blank] | [blank] | ... |
| Skill B | 15 | +1 | [blank] | [blank] | [blank] | ... |
| Skill C | 10 | 0 | [blank] | [blank] | [blank] | ... |
| Skill D | 14 | -1 | [blank] | [blank] | [blank] | ... |

In such an example MSK matrix, calculated MST vector entries (which may be referred to as “missing resource indices”) indicate that, for the initial candidate considered: two agents are still missing for satisfying service metrics required for skill A; one agent is required for satisfying such metrics for skill B; and skill D is over allocated or staffed (e.g., predicted service metrics for the allocation candidate at hand exceed the required metrics). Alternative data formats and/or entries for an MSK matrix or equivalent data structures may be used in different embodiments of the invention.

Embodiments may then search or query the calculated MST vector and/or missing resource indices to determine whether agents are missing in order to satisfy the required service metrics (block D.4.; see also discussion relating to required and predicted service metrics with regard to FIGS. 3-4 herein), which may be indicated, for example, by positive values found in MST vector entries (also referred to as missing resource indices) as in the example shown in Table 4 herein.

If agents are missing (such as, e.g., if one or more missing resource indices are positive and/or are greater than a predetermined threshold), embodiments may automatically draw, sample, or select an agent from a pool of agents (block D.5.). Such pool of agents may be or may include, e.g., the multi-skill agent distribution calculated at block D.1. In some embodiments, an agent may be probabilistically sampled from the distribution according to the relative weights of each skill group. For example, given the distribution depicted in FIG. 12, embodiments may sample an agent having the skill set of {A, B} at a probability of 50%, or an agent having the skill set of {A} at a probability of 25%. Different agent sampling protocols or procedures may be used in different embodiments of the invention.

Embodiments may then derive, extract or calculate a resource or agent matrix representation or model for the agent sampled (block D.6.). The model may have the shape of (|skills|) and include or describe the skills of the relevant agent according to the distribution from which the agent was sampled, such as, e.g., Table 3 or FIG. 12 herein.

An example agent representation model is shown in Table 5:

TABLE 5

| | Agent A |
|---|---|
| Skill A | 1 |
| Skill B | 0 |
| Skill C | 1 |
| Skill D | 0 |

where it is shown that agent A “possesses” or has features or skills A and C. In some embodiments, the left row may be omitted from the agent model. Alternative formats and/or data structures may be used for agent representation models is different embodiments of the invention.

Embodiments may then check if the agent or model is “relevant” for improving, or “contributing to” the satisfying of the required service metrics by the allocation candidate, e.g., as described in the MSK matrix (block D.7.). In some embodiments of the invention, the sampled agent or model may be considered relevant based on possible contributions to at least one required service metric, e.g., according to the following, example scenarios:
a) Direct contribution: (i) the allocation candidate does not satisfy required service metrics for at least one of the skills included in the agent’s model; or (ii) the model includes at least one skill for which a positive value is indicated in the MST vector (which may mean, e.g., that the sampled agent may directly handle additional workload for which the skill is required).
b) Indirect contribution: the sampled agent may free another, second agent already included in the allocation candidate (such as, e.g., the updated allocation matrix), from being assigned to a given feature or skill X, such that the agent may be reassigned to a different feature or skill Y to which a direct contribution may be made. In some embodiments, an indirect contribution may only be made if, for example: (i) the second agent has at least one skill in common with the sampled agent; (ii) the volume of workload associated with the skills common to the two agents is greater than zero; and (iii) the second agent has another skill for which a positive value is indicated in the MST vector.

Additional or alternative definitions and/or conditions for contributions by a sampled agent (which may, for example, be derived from the feature or skill distribution received in block D.1.) may be used in different embodiments of the invention.

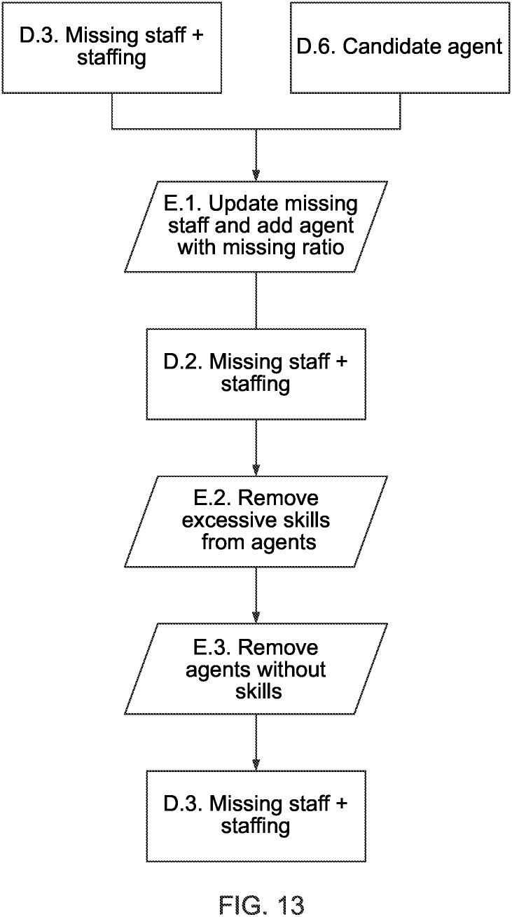

If the sampled agent is found relevant for improving the allocation candidate, embodiments may then update the MSK matrix based on the selected agent’s model — for example, by adding the sampled agent’s model to previously added models already included in the MS matrix and populating blank spaces in the MSK matrix — as well as by updating the MST vector or missing resource indices (block D.8.; see additional discussion regarding the updating of the MSK matrix as outlined in in FIG. 13 herein). If the agent is found irrelevant for improving the allocation candidate — the process may return to block D.5. and a substitute agent may be sampled from the pool of agents as described herein.

An example MSK matrix which may be provided in block D.8. is shown in Table 6:

TABLE 6

| | Initial Candidate | MST Vector | Multi-Skill Agent Models | | | |
|---|---|---|---|---|---|---|
| | | | A | [blank] | [blank] | ... |
| Skill A | 15 | +1 | 1 | [blank] | [blank] | ... |
| Skill B | 15 | +1 | 0 | [blank] | [blank] | ... |
| Skill C | 10 | 0 | 1 | [blank] | [blank] | ... |
| Skill D | 14 | -1 | 0 | [blank] | [blank] | ... |

In this example, agent A as described by the example model in Table 5 was added to the MS matrix and the MST vector has been updated (the entry for skill A has changed from +2 to +1; however, see also discussion regarding the updating of the MST vector with reference to FIG. 13 herein).

Following the execution of block D.8., the process may return to block D.3., e.g., where the updated allocation candidate may be considered as an input for a subsequent iteration (e.g., in which blocks D.4.- D.8. may be executed once more).

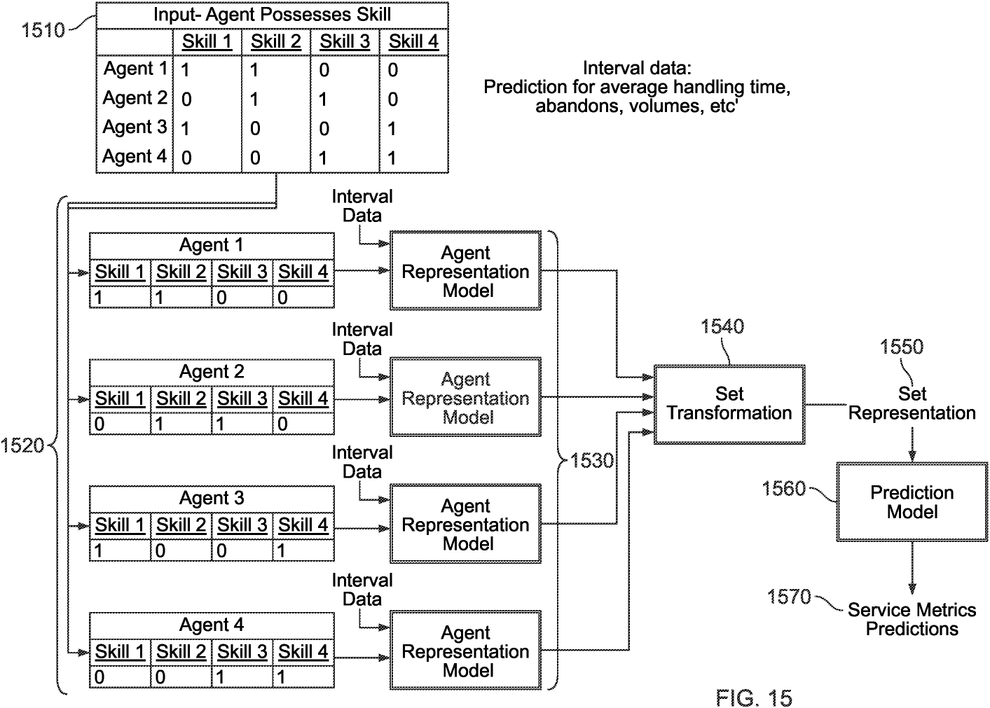

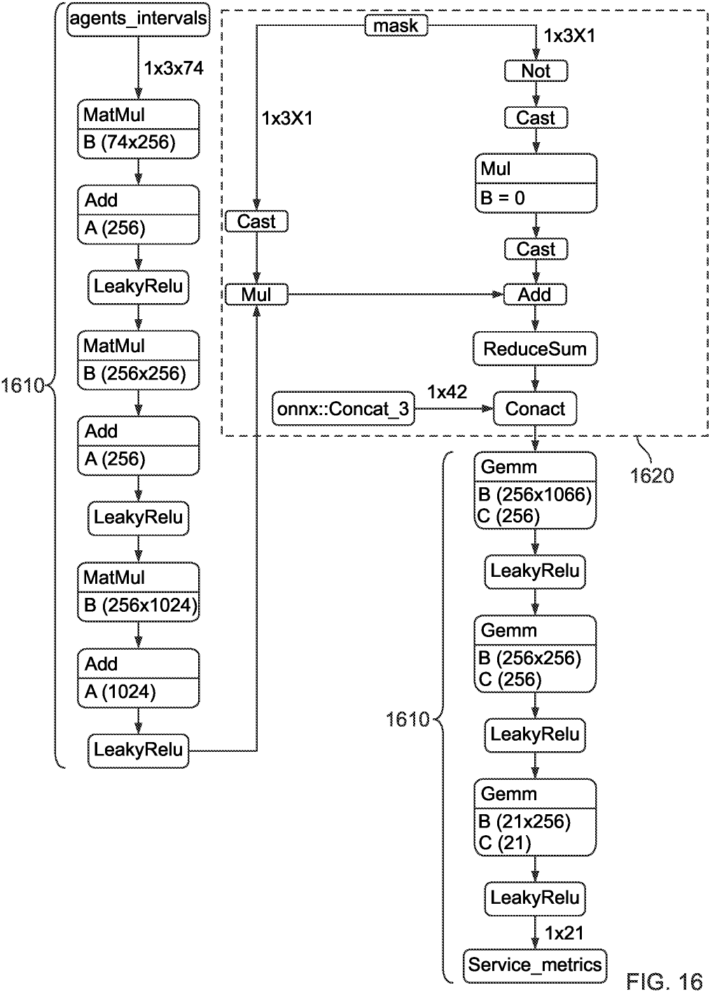

Following a final iteration (e.g., in case no more agents are missing according to block D.4.), a final multi-skill allocation matrix or candidate may be provided (block D.9.). In some embodiments, the final candidate may include and/or correspond to and/or be extracted from, the updated |agents|x|skills| component in the MS matrix following the final iteration. In other embodiments, however, an allocation matrix such as provided in block D.9. may be further returned and included in, e.g., further iterations of some of the procedures outlined herein, such that a final allocation candidate may be provided after further refinement and following additional comparisons of predicted service metrics to required metrics (see, e.g., discussions referring to FIGS. 4-5, as well as FIGS. 15-16 herein).

A workflow and process such as depicted in FIG. 11 — as well as similar and/or equivalent processes — may thus intertwine a few related functionalities, sub-flows, or sub-processes, such as, e.g.,: (A) reformatting and/or transforming an initial allocation candidate into an MS matrix or updated allocation matrix/candidate; (B) sampling agents from a pool of agents and checking their relevance to the updated or transformed allocation matrix; and (C) populating the updated allocation matrix with additional relevant or missing agents. The description of the example workflow depicted in FIG. 11 may focus on the order execution of different sub-operations or tasks, rather than on distinguishing the three sub-processes (A)-(C) from one another. For example, the step of receiving a multi-skill agent distribution, which relates to subprocess (B), may be discussed in the beginning of the process and before various steps relating to subprocess (A). However, one skilled in the art may attribute each of the steps or operations considered in FIG. 11 to the appropriate subprocess which may necessitate it. One skilled in the art may further recognize that alternative embodiments of the invention may execute workflows different from the example workflow described herein, or variations on the workflow described in FIG. 11 (see, for example, discussion with regard to FIGS. 15-16 where slightly different data flows may be used) — and that some alternative workflows may, e.g., execute each of sub-processes (A)-(C) in a sequential manner, such that the sub-processes would be distinct from one another.

In some embodiments, the updated or final allocation candidate may be transformed or converted back into a single-sum-of-time (SSOT) format (e.g., the format of the initial allocation candidate). Such conversion may be beneficial, for example, for ensuring the compatibility of the different protocols and procedures outlined herein, which may use different formats for allocation candidates. Thus, a format conversion may take place, e.g., following the generation of an appropriate updated or final allocation matrix, (e.g., as may be provided in block D.9.), such that the appropriate format may be used as an input for a machine learning model which may be used for predicting service metrics as described in FIGS. 3-7 herein. In some embodiments, such transformation or conversion may be, e.g., a set transformation procedure which may be implemented into a neural network model architecture as further described herein.

In some embodiments, e.g., as part of block D.8., the MSK matrix and MST vector may be updated to account for the addition of a multi-skill agent or model in, e.g., blocks D.5.-D.6. As noted herein, the procedure may be used for indicating how many agents may still be required, or should still be added, to satisfy the required service metrics. Such a procedure may thus be used, for example, to provide an indication of this sort such that further iterations of blocks D.4.-D.8. may be carried out, until an updated or final allocation matrix from which no additional agents are missing may be input into a machine learning model, e.g., as discussed herein with reference to FIGS. 3-4, and/or FIGS. 6-7.

FIG. 13 illustrates an example procedure of updating the missing staff vector according to some embodiments of the invention.

In block E.1., embodiments may update MST vector entries in the MSK matrix in the following manner:
a. The newly-added agent’s skills may be collected from the agent’s model (where they may be represented by, e.g., non-zero entries as shown in Table 5).
b. The collected skill entries may be scaled and subtracted from the corresponding missing resource indices in the MST vector, e.g., based on the relative magnitude of the indices, e.g., according to:
$$\left(\left|n , m , …\right|\right) \to \left(\left|n - \frac{n}{n + m + ⋯} , m - \frac{m}{n + m + ⋯} , …\right|\right)$$

For example, given a newly-added agent having a skill set of {A, B}, and a MST vector having corresponding positive entries (|2,1|), which may indicate that two agents of skill A and one agent of skill B may be missing for satisfying the required service metrics for the time interval considered — embodiments may update or recalculate the MST vector entries, as:

$$\left(\left|2 , 1\right|\right) \to \left(\left|2 - \frac{2}{3} , 1 - \frac{1}{3}\right|\right) = \left(\left|\frac{4}{3} , \frac{2}{3}\right|\right)$$

Thus, the newly-added agent may be assigned to spend ⅔ of his time using skill A and ⅓ of his time using skill B. In such manner, positive entries in the MST vector may therefore signify the urgency of allocating more agents for tasks involving a given skill within the time interval considered, and a newly-added agent may therefore be allocated to use the skills that may be more urgently needed. However, different formulas and corresponding allocations schemes may be used in different embodiments of the invention.

Following the updating of the missing staff vector, the updated MSK matrix may still require further updating, and the allocation candidate search algorithm or procedure as, e.g., outlined in FIG. 11, may thus return to block D.2 such that additional steps (e.g., as described in blocks E.2.-E.3.) may follow prior to proceeding to block D.3.

Embodiments may remove features or skill entries from agent models in the MSK matrix, in case the relevant entries match negative MST vector indices or values (which may indicative of, e.g., excessive and thus wasteful allocation of agents for tasks involving the relevant skill; block E.2.). For example, embodiments may query or search the MST vector for negative values; if such value is found for a given skill, embodiments may randomly choose or select one or more of the agent models in the MSK matrix, and remove the relevant skill from the selected models. In some embodiments, the number of randomly selected agent models may be determined according to the magnitude of the corresponding negative value in the missing staff vector: for instance, if a value of -2 exists for skill A, two agent models may be selected. Alternative selection schemes, however, may also be used in different embodiments of the invention.

Following the removal of skill entries from agent models, embodiments may further remove or delete agents or models for which all feature or skill entries were removed, or for which no skill entries have remained, from the MSK matrix or updated allocation candidate (block E.3.), for example to prevent excessive allocation of agents which may be kept idle during the time interval under consideration.

Based on multi-skill allocation procedures such as illustrated in FIGS. 10-11 and 13, embodiments of the invention may allocate and/or assign agents to execute incoming workload requiring a particular skill for its execution. The updated allocation candidate may thus be a multi-skill allocation candidate calculated or determined based on an initial single-skill allocation candidate, e.g., as provided and described with reference to FIGS. 3-4 herein. While embracing a previously unexplored multi-skill perspective on agents, some embodiments may avoid (1) under-assigning agents and/or multi-skill agents to meet the required service metrics, and (2) greedily allocating or assigning agents having all/most required skills and being, e.g., unique (and for example more valuable) compared to other agents in the pool of agents considered. Embodiments of the invention may thus enable improved resource utilization and efficiency (e.g., in an organization such as for example a call or contact center) while preventing the possible exploitation of particular, limited resources.

Various data processing and/or transformation procedures used in different embodiments of the invention (such as, for example, ones discussed with reference to FIGS. 3-4, 6, 11 and 13 herein) may be embedded or implemented in dedicated machine learning model architectures.

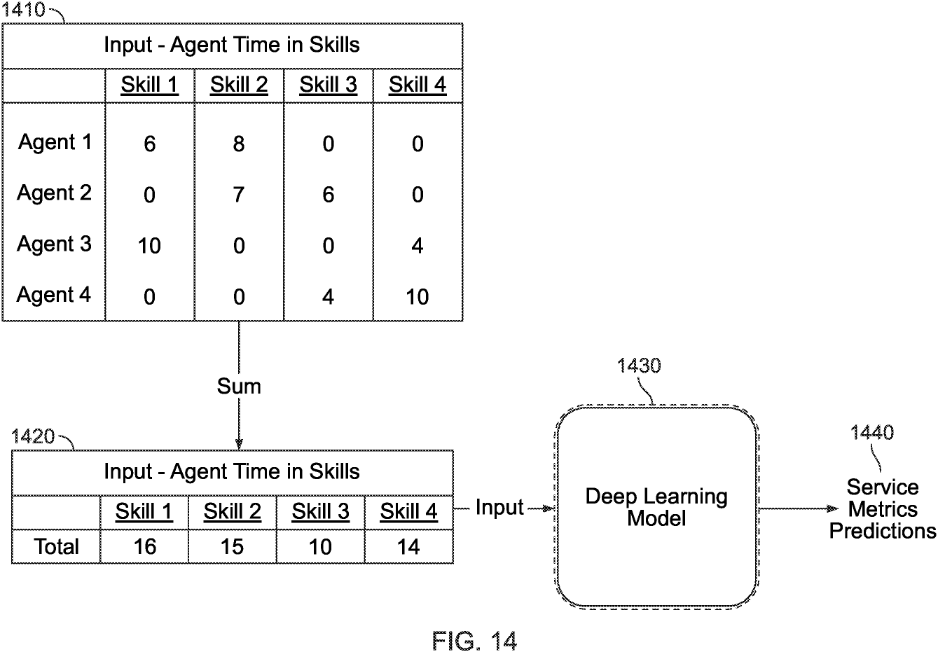

FIG. 14 is a high-level block diagram showing a first example machine learning model architecture according to some embodiments of the invention. Some embodiments of the architecture depicted in FIG. 14 may be implemented in, e.g., a lower-level neural network multilayer structure as illustrated and considered with reference to FIG. 6 herein.

Data items 1410 may serve as a starting point, and may describe, e.g., for a given time interval, a plurality of time increments spent by each of agents 1-4 using each of skills 1-4. For example, each time increment may amount to a single business hour, and the time interval considered may amount of one week; thus 6 hours may be spent by agent 1 using skill 1 (which may be needed, e.g., for sales work), 8 hours may be spent using skill 2 (e.g., on customer service), and so forth.

Elements such as, e.g., data items 1410 may be converted and used as training data (for example in case their contents describe historic allocation information) or as allocation candidates for which service metrics may be predicted. Thus, time increments for all agents may then be summed or binned into total time increments per skill 1420, e.g., in a SSOT format for the time interval under consideration. Total time increments per skill 1420 may, in turn, be input to deep learning model 1430 (which may, e.g., be a model as described with reference to FIGS. 6-7 herein). Once trained using data such as total measured times per skill X20, Deep learning model 1430 may output a plurality of service metrics predictions 1440 based on, e.g., data items 1410 as described herein with reference to FIGS. 3-5.

It may be reasonably understood, however, that different model architectures, as well as corresponding data representations and training workflows as used in different embodiments of the invention may lead to different predictions. For example, a model architecture such as, e.g., the one described in FIG. 14 may not distinguish between the two example input data items in Tables 7-8:

TABLE 7

Input — Agent Time in Skills

| | Skill 1 | Skill 2 |
|---|---|---|
| Agent 1 | 5 | 0 |
| Agent 2 | 0 | 5 |
| Total | 5 | 5 |

TABLE 8

Input — Agent Time in Skills

| | Skill 1 | Skill 2 |
|---|---|---|
| Agent 1 | 2 | 3 |
| Agent 2 | 3 | 2 |
| Total | 5 | 5 |

in which the summed or binned total time per skill values may be identical and equal 5 for each of the two skills included in the input data. For this reason, the model architecture of FIG. 14 may not be appropriate or desirable for handling or describing multi-skill agent allocations, and a different architecture may be required.

FIG. 15 is a high-level block diagram showing a second example machine learning model architecture according to some embodiments of the invention.

Data items 1510 may include or describe, for example, a multi-skill agent distribution or allocation candidate or data, including multi-skill agents 1-4, in which it may indicated whether a given agent “possesses” or has skills 1-4 (see corresponding discussion with regard to, e.g., block D.1 herein).

In some embodiments, items such as data items 1510 may be derived from, or calculated based on, elements such as items 1410, e.g., by assigning “1” to skills for which time increments in data items 1410 are greater than zero, and assigning “0” to all other skills. In such manner, for example, some embodiments may calculate or generate multi-skill agent data such as multi-skill agent distributions and/or allocation candidates based on time increment data items.

Individual agent data or agent models 1520 may be drawn of selected from data items 1510 such that individual agents — as opposed to a plurality of agents in aggregate — may be described (e.g., contrary to data items 1420 and as illustrated with regard to Tables 7-8; see also corresponding discussion with reference to block D.6. herein).

Agent representation models 1530 may be further transformed, derived, extracted or calculated based on data items 1520.

In some embodiments, and for example in addition to the procedure described in block D.6., the derivation of an agent representation model 1530 may be further applied to individual agent data 1520 or prior agent models such as, e.g., described in Table 5. — and performed based on, e.g., additional time interval data to provide, e.g., a transformed agent model. For example, a given time interval considered for allocation purposes may allow for shifting or changing skills relevant to some agents — e.g., a skill of “customer support” may be converted into a skill of “complaints” in case time interval data indicates that “customer support” phone lines may not be available during the time interval considered, and in case it is indicated that for that time interval, a ““customer support” skill may be sufficient for handling customer “complaints”.

Additionally or alternatively, some embodiments may transform or convert agent models and/or the updated or final allocation matrix into various formats or data representations, and to include additional data and/or information entries — e.g., along different neural layers within am appropriate machine learning model. In this context, see also, e.g., FIG. 16 and related discussion herein.

A set transformation procedure 1540 may then be applied to agent representation models 1530 and/or the updated or final allocation matrix, for example in order to combine, unify, or merge agent models and/or convert an allocation candidate into a unified set representation 1550. In some embodiments, set representation 1550 may conform to a single-sum-of-time (SSOT) format (e.g., as may be used for the initial allocation candidate, and as described herein with regard to FIGS. 3-4). Set representation 1550 may then be input to prediction model 1560 (e.g., either as training data, in case data items 1510 refer to historic allocation data, or as allocation candidates for which service metrics should be predicted, e.g., as discussed herein with regard to step 506 in FIG. 5).

Being trained using data items such as item 1510, prediction model 1560 may output a plurality of service metrics predictions 1570 (e.g., as described with regard to block B.5.).

An example model architecture such as, e.g., the one described in FIG. 15 may, in fact, distinguish between the two input data items described in Tables 7-8 based on the particular skills used by each of the agents considered. It may thus be more appropriate for handling multi-skill agent data compared to its example counterpart described with reference to FIG. 14.

FIG. 16 is a diagram showing a second example structure of a neural network according to some embodiments of the invention. While some embodiments may be modeled after the general, permutation invariant DeepSets model and neural network architecture, one skilled in the art may recognize that alternative model architectures may be used in different embodiments of the invention.

Input data, which may describe, e.g., a plurality of agents’ time increments within a time interval (such as, e.g., described with regard to items 1410) may be received by an input layer among shallow layers 1610, which may perform additional operations relating to, for example, converting or transforming data items 1510 into individual agent data 1520. In this context, “MatMul” and “Add” layers may be used to perform arithmetic operations (such as ones required, e.g., for converting data items 1410 into items 1510), which may be generally connected to a plurality of “LeakyRelu” layers having a ReLU activation function (see discussion relating to FIG. 6 herein).

Intermediate layers 1620 may account for, e.g., generating agent representation models 1530; updating the MSK matrix (e.g., according to blocks D.3.-D.8. as discussed herein) based on individual agent data items 1520; and transform the updated or final allocation candidate and/or agent representation models into a set representation (which may conform, for example, to an SSOT format as described with reference to FIG. 11). Intermediate layers 1620 may thus include, for example, layers performing additional arithmetic and/or logical and/or data processing operations such as, e.g., “Mul”, “Not”, “ReduceSum”, “Cast” and “Concat” layers (e.g., to associate different sources of input data); an “onnx:Concat_3” layer which may be used, e.g., for linking or associating workload or volume data (as well as additional metrics such as the AHT) with skills in agent matrices or representations, such that the neural network may generate service level predictions based on the associated data; and a “mask” layer which may, for example, group together multiple data points (such as the plurality of time increments considered) and feed them to subsequent model layers in batches (e.g., in a simultaneous manner). Such mask layer may also include or involve reformatting of different agent matrices to conform to a single format or length — which may be chosen, for example, as the dimensions of the largest agent matrix in the batch — and removing or masking matrix entries (for example by appropriate arithmetic operations on selected entries — such as, e.g., multiplication by 0) which may, e.g., be considered as irrelevant to the staffing procedure as a whole.

Prediction layers 1630 may, e.g., receive the transformed agent data items or allocation candidate from intermediate layers 1620 and predict a plurality of service metrics which may be received in the final of bottom layer (e.g., as described with reference to block B.5.). In this context, and as part of prediction layers 1630, additional LeakyRelu layers may be connected to “Gemm” layers, that may apply additional arithmetic operations, e.g., using a protocol such as for example the General Matrix Multiply (GeMM) algorithm.

It may be recognized that a high-level example architecture such as, e.g., depicted in FIG. 15 may be implemented in lower-level neural network structures such as, for example, described with reference to FIG. 16. However, different data formats/representations and machine learning model architectures (including, but not limited to, those depicted in FIGS. 6, and/or 14-16 — and/or including different operations and/or data transformations or manipulations among neural network layers), as well as different model training workflows, may be used in different embodiments of the invention. One skilled in the art may recognize that such workflows, architectures, and representations may differ in the nature and content of information being input into the model, and that different embodiments may accordingly be chosen and used in appropriate contexts - e.g., as demonstrated herein with regard to the model architectures illustrated in FIGS. 14-15 and their potential for handling multi-skill agent data.

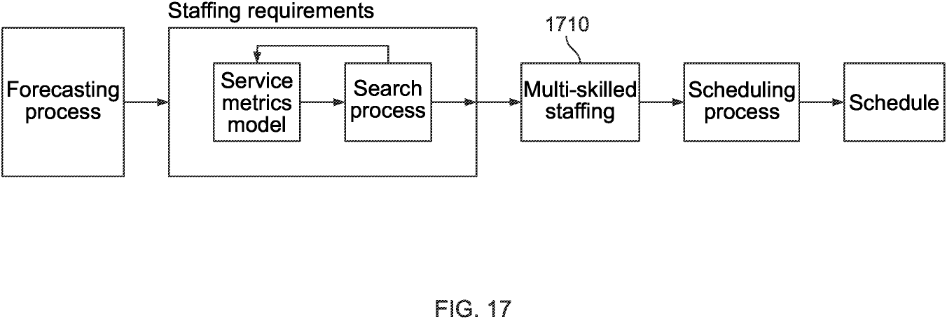

FIG. 17 illustrates a second example of a system according to some embodiments of the present invention. In addition to, e.g., elements included and discussed with reference to FIG. 8, a multi-skill agent allocation process (such as, for example, discussed with reference to FIGS. 10-11, and 13) may be implemented in a dedicated component or module 1710, for example in order to account for multi-skill agents and/or recommend an allocation composition of multi-skill agents, while ensuring compatibility with embodiments of the invention adapted for single skill agents — e.g., by applying appropriate transformations to and from an SSOT format as described herein. In some embodiments, module 1710 may bridge, e.g., elements 804 and 810, for example, in accordance with the workflow shown in FIG. 10, although additional or alternative implementations may be used in different embodiments of the invention.

Embodiments of the invention may provide a graphical user interface for defining and applying parameters, constraints and conditions to multi-skill agent allocation related procedures, such as, e.g., ones described with reference to FIGS. 10-11 and 13.

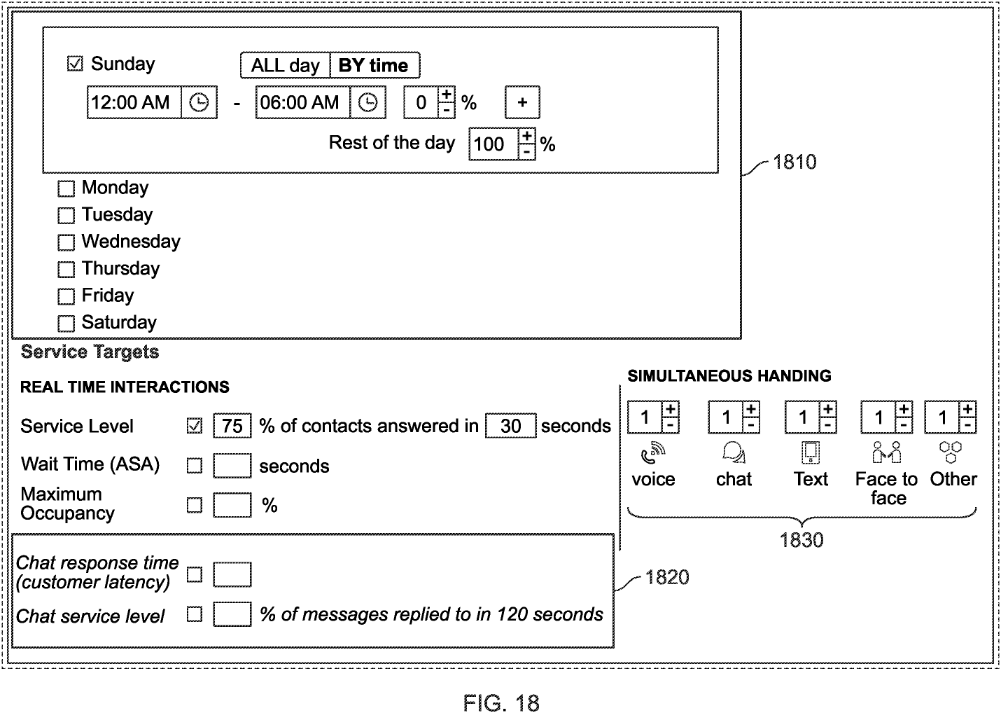

FIG. 18 is a second example graphical user interface according to an example embodiment of the invention.

In addition to, e.g., elements considered herein with reference to FIG. 9, embodiments may provide, e.g., time interval allocation controls 1810 which may allow a user to input a time interval (e.g., between specified hours such as 12:00 AM — 06:00 AM) and allocation occupancy (e.g., how many agents among a “full capacity of agents”, or 100% capacity) for a given day (e.g., Sunday) for which an allocation candidate may be searched and provided by embodiments of the invention.

Additional required service targets or metrics 1820, such as described with reference to block A.2., may be defined by a user using the graphical interface and include, e.g., a “chat response time” or “customer latency” metrics, as well as a “chat service level” metric, may also be provided by some embodiments of the invention.

Embodiments may provide a user with simultaneous task or skill handling controls 1830 that may introduce a plurality of constraints on, e.g., the simultaneous handling of tasks by agents, as may be reflect in agent models or feature matrices that may accordingly be included or implemented in allocation matrices produced by embodiments of the invention. In this context, user constraints may specify “allowed” or “forbidden” simultaneous handlings of tasks or task types by the agents considered. For example, values of ‘1’ for all tasks types “voice”, “chat”, “text”, “face-to-face” and “other” may indicate that agents may be allocated to perform all five task types simultaneously (thus, for example, embodiments may consider 5-skill agents in allocation candidates as part of a process such as outlined in FIG. 11) — while values of ‘0’ would have forbidden the corresponding task type from being performed simultaneously to allowed tasks. Thus, the transforming of an initial allocation matrix or candidate into an updated or final matrix or candidate may be performed based on the constraints input by a user (for example, tasks specified as forbidden by a user may be removed from skill groups or records in the agent database and/or skill distribution, and/or from agent models included in the MSK matrix).

Additional or alternative controls and graphical user interfaces enabling a user to, e.g., define or input conditions or constraints relating to allocation candidates may be used in different embodiments of the invention.

Additionally or alternatively to providing staffing requirements or allocation candidates to a scheduling system as described herein, embodiments of the invention may allow automatically executing a plurality of computer tasks, e.g., by a computer remote and/or separate from the computer system responsible for, and/or executing the allocation or staffing related procedures described herein. In this context, embodiments may transmit or send an allocation candidate such as, e.g., a final allocation matrix — for example over a communication network and using a NIC as described with reference to FIG. 1 — to a physically-separate or remote computer. In such manner, and upon receiving the final allocation matrix, the remote computer may automatically execute one or more computer tasks based on the final matrix.

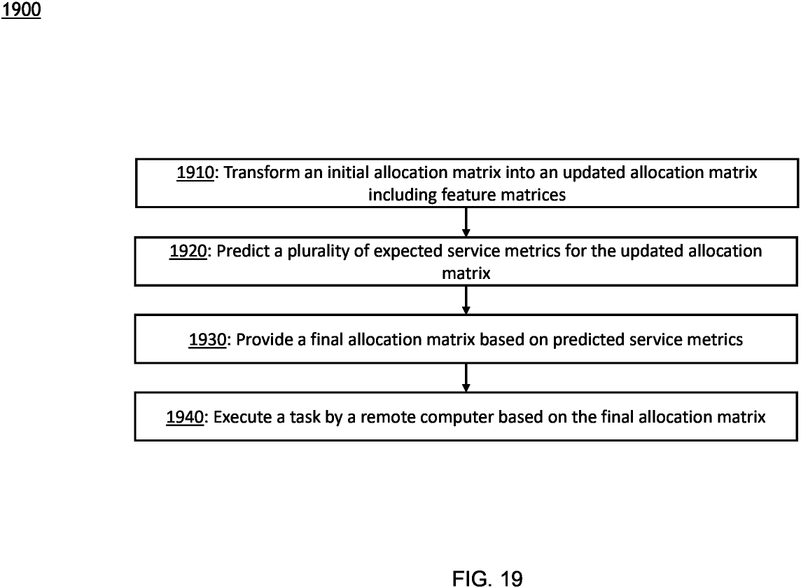

FIG. 19 shows an example method 1900 for allocating resources according to some embodiments of the invention.

In step 1910, embodiments may transform an initial allocation matrix into an updated allocation matrix (such as, e.g., an MSK matrix as described in in Tables 4 and 6 and with reference to FIG. 11) — where the updated matrix may include a plurality of feature matrices (which may be, e.g., agent models as described in Table 5). Each agent or feature model may describe, for example, a resource among a plurality of resources, as noted with reference to FIG. 11 herein.

In step 1920, embodiments may predict a plurality of expected service metrics for the updated allocation matrix (e.g., by a machine learning model, for example as described with reference to FIGS. 15-16, and after iteratively updating an MSK matrix based on MST vector values, e.g., as described with reference to FIG. 11).

In step 1930, embodiments may provide a final allocation matrix based on the predicted service metrics (for example based on following a final iteration as described with reference to block D.9., and/or after comparing predicted service metrics to required service metrics, e.g., as described with reference to FIG. 5, and iteratively repeating an allocation candidate search algorithm such as, for example, described in FIGS. 4, 10, 11-13 herein).

In step 1940, embodiments may execute at least one computer task based on the final allocation matrix by a remote or physically-separate computer. For example, an allocation matrix or assignment such as, e.g., provided in blocks C.3. and/or D.8. may be found to match or correspond to the allocation or staffing requirement plan as provided in block A.4., and/or to the required service metrics as provided in block A.2. (for example based7 on a procedure such as outlined in FIG. 4 herein). Embodiments may then search resource descriptions or a database of resources (which may be, for example, a resource distribution including a plurality of feature groups, such as demonstrated in Table 3), and select resources among the plurality of resources in the database for allocation based on appropriate skill or feature population levels. Selected resources may thus be allocated for the relevant interval given as input to the various protocols and procedures outlined herein. When the time interval begins, embodiments may, for example, send or transmit a task execution request or submit a job file to the resources selected and allocated based on the relevant allocation matrix. Such request may, for example, be sent or transmitted to a physically separate or remote computer or computing system over a communication network and specify technical requirements for a task or job execution. A resource such as, e.g., a remote computer may then receive the request or file and automatically execute the computer task or calculation to which it was assigned, e.g., based on the final allocation matrix as provided by embodiments of the invention.

As a non-limiting example, embodiments may provide an allocation matrix or candidate where a plurality of remote computing systems may be assigned to solve a computationally costly optimization problem (such as for example that of finding a ground state electronic wavefunction for a multi-electron molecular system) within a given time interval (for example three days). Embodiments may subsequently select a set of relevant computing systems available, for example, within a relevant high-performance cluster or cloud platform based on the allocation matrix and resource availability information (such as a resource or agent distribution as described herein). Only systems including required skills or features (such as, e.g., CPU or GPU units of a specific model or architecture) may be selected. Embodiments may then send a task execution request or job file to each of the selected or allocated resources, e.g., at the point where the relevant time interval begins. The request or file may include, for example, the amount of RAM and/or processing cores required for performing the calculation, in addition to input parameters defining the starting point of the calculation (such as, e.g., an input molecular geometry as defined by nuclear coordinates), a minimum number of optimization cycles or iterations, and the like. Upon receiving and reading the task execution request or job file, allocated remote computers may automatically execute the requested job or computer task, e.g., as known in the arts pertaining to distributed computing systems.

As part of method 1900, the initial allocation matrix may associate each resource with a single feature, that is, the initial matrix may describe resources or agents in a single-skill framework, e.g., as discussed herein with reference to blocks B.3. and C.2. The updated and/or final allocation matrix, on the other hand, may associate at least one resource with at least two features or skills — e.g., as demonstrated with reference to agent models and MSK matrices, for example in Tables 5-6 herein and more generally discussed with reference to FIGS. 11, 13, and 15 herein.

Additionally or alternatively, method 1900 may further include calculating one or more missing resource indices for the initial matrix, which may represent a resource capacity or missing resources needed for satisfying at least one required service metric. Such missing resource indices may be, e.g., entries in the MST vector calculated in, e.g., blocks D.2. and E.1., and illustrated in Tables 4 and 6. Then, if missing resource indices are larger than a predetermined threshold (such as, for example, if some or any of the entries in the MST vector are positive, as described with reference block D.4.) a resource may be automatically selected from a database of resources (which may be or may include for example a multi-skill agent distribution such as described in Table 3 or in FIG. 12) and added to the updated allocation matrix such that the resource may be contributing to one or more of the required service metrics (e.g., according to blocks D.5.-D.8.). In some embodiments, the automatically selected resource may be probabilistically sampled from the database or resources according to a relative weight of each relevant feature group in the database, such as for example described with reference to block D.5. Some embodiments of the invention may further include updating missing resource indices, for example, based on the feature matrix for the automatically selected resource and the relative magnitudes of the missing resource indices — as, e.g., described with reference to block E.1. herein. In some embodiments, the selected resource may free a second resource from being assigned to a given feature, where the second resource may be already included in the updated allocation matrix — as for example described herein with reference to block D.7.

Additionally or alternatively, method 1900 may further include calculating, by the machine learning model, a transformed representation for each of the feature matrices (such as, e.g., described in step 1530 — where representation models may be derived from individual agent data 1520 in addition to time interval data; see also, e.g., FIG. 16 as to implementation of such transformation in a neural network architecture). Transformed representations may then be merged, by the machine learning model, into a unified representation (such as, e.g., set representation 1550), which may then be used for predicting expected service metrics 1570 (for example by being input to prediction model 1560). In some embodiments, the merging of transformed representations may be performed, for example, according to a plurality of matrix multiplication and/or various additional or alternative arithmetic operations across neural layers such as, e.g., described with reference to FIG. 16 herein.

In some embodiments, method 1900 may further include removing one or more features from one or more feature matrices of resources included in an allocation matrix, e.g., in case missing resource indices indicate that a given feature is associated with over allocation — for example as described herein with reference to block E.2. Some embodiments may further remove a resource from the allocation matrix if all features were removed from the feature matrix for the resource considered, e.g., as described with reference to block E.3.

Additionally or alternatively, method 1900 may include introducing one or more constraints on the feature matrices, where the constraints may specify various allowed simultaneous handlings of tasks or combinations of tasks —as for example described with reference to simultaneous task or skill handling controls 1830 in FIG. 18 herein. In such manner, the transforming of an initial allocation matrix into an updated allocation matrix — such as for example described herein according to the example procedure outlined in FIG. 11 — may be performed based on the constraints for simultaneous handlings of tasks, e.g., by removing “forbidden” combinations of tasks from feature groups or feature matrices as described with reference to simultaneous task or skill handling controls 1830 in FIG. 18.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer’s registers and/or memories into other data similarly represented as physical quantities within the computer’s registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for allocating resources, the method comprising:
in a computerized-system comprising a processor:
transforming, by the processor, an initial allocation matrix into an updated allocation matrix, wherein the updated allocation matrix comprises a plurality of feature matrices, each feature matrix describing a resource among a plurality of resources;
predicting, using a machine learning (ML) model, at least one expected service metric for the updated allocation matrix; and
providing, by the processor, a final allocation matrix based on the at least one expected service metric.

2. The method of claim 1, wherein initial allocation matrix associates each resource among the plurality of resources with a single feature of a plurality of features; and
wherein the updated allocation matrix associates at least one resource among the plurality of resources with at least two features of the plurality of features.

3. The method of claim 2, comprising calculating, by the processor, one or more missing resource indices for the initial matrix, the indices representing a resource capacity needed for satisfying at least one required service metric; and
if one or more of the indices are larger than a predetermined threshold, automatically selecting, by the processor, a resource from a database of resources and adding the selected resource to the updated allocation matrix, the selected resource contributing to the at least one required service metric.

4. The method of claim 1, comprising calculating, by the ML model, a transformed representation for each of the feature matrices;
merging, by the ML model, the calculated transformed representations into a unified representation; and
wherein the predicting of at least one service metric is performed based on the unified representation.

5. The method of claim 1, automatically executing, by a computer separate from the processor, at least one computer task based on the final matrix.

6. The method of claim 3, wherein the database of resources comprises a resource distribution, the distribution including a plurality of feature groups; and
wherein the automatically selected resource is probabilistically sampled from the database according to a relative weight of each feature group.

7. The method of claim 3, comprising updating, by the processor, one or more of the indices, the updating based on a feature matrix for the automatically-selected resource, and based on relative magnitudes of one or more of the indices;
for one or more negative missing resource indices, removing, by the processor, one or more of the features from one or more of the feature matrices; and
if all features were removed from a given feature matrix, removing, by the processor, the given resource from the updated allocation matrix.

8. The method of claim 1, comprising introducing one or more constraints on one or more of the feature matrices, the constraints specifying allowed simultaneous handlings of tasks; and
wherein the transforming of an initial matrix into an updated matrix is performed based on the constraints.

9. The method of claim 3, wherein the selected resource frees a second resource from being assigned to a given feature, the second resource included in the updated allocation matrix.

10. A computerized system for allocating resources comprising:
a memory; and
a computer processor, the processor configured to:
transform an initial allocation matrix into an updated allocation matrix, wherein the updated allocation matrix comprises a plurality of feature matrices, each feature matrix describing a resource among a plurality of resources;
predict, using a machine learning (ML) model, at least one expected service metric for the updated allocation matrix; and
provide a final allocation matrix based on the at least one expected service metric.

11. The computerized system of claim 10, wherein initial allocation matrix associates each resource among the plurality of resources with a single feature of a plurality of features; and
wherein the updated allocation matrix associates at least one resource among the plurality of resources with at least two features of the plurality of features.

12. The computerized system of claim 11, wherein the processor is to:
calculate one or more missing resource indices for the initial matrix, the indices representing a resource capacity needed for satisfying at least one required service metric; and
if one or more of the indices are larger than a predetermined threshold, automatically select a resource from a database of resources and add the selected resource to the updated allocation matrix, the selected resource contributing to the at least one required service metric.

13. The computerized system of claim 10, wherein the processor is to:
calculate, by the ML model, a transformed representation for each of the feature matrices;
merge, by the ML model, the calculated transformed representations into a unified representation; and
wherein the predicting of at least one service metric is performed based on the unified representation.

14. The computerized system of claim 10, wherein the processor is to:
transmit a task execution request to a remote computer over a communication network, the remote computer to automatically execute at least one computer task based on the final matrix.

15. The computerized system of claim 12, wherein the database of resources comprises a resource distribution, the distribution including a plurality of feature groups; and
wherein the processor is to probabilistically sample the automatically selected resource from the database according to a relative weight of each feature group.

16. The computerized system of claim 12, wherein the processor is to:
update one or more of the indices, the updating based on a feature matrix for the automatically-selected resource, and based on relative magnitudes of one or more of the indices;
for one or more negative missing resource indices, remove one or more of the features from one or more of the feature matrices; and
if all features were removed from a given feature matrix, remove the given resource from the updated allocation matrix.

17. The computerized system of claim 10, wherein the processor is to:
introduce one or more constraints on one or more of the feature matrices, the constraints specifying allowed simultaneous handlings of tasks; and
wherein the transforming of an initial matrix into an updated matrix is performed based on the constraints.

18. The computerized system of claim 12, wherein the selected resource frees a second resource from being assigned to a given feature, the second resource included in the updated allocation matrix.

19. A method for allocating resources, the method comprising:
in a computerized-system comprising a processor:
converting, by the processor, an initial staffing candidate into a multi-skill staffing candidate, wherein the multi-skill staffing candidate comprises a plurality of models, each model describing a resource among a plurality of resources;
generating, using a neural network, at least one expected key performance indicator (KPI) for the multi-skill staffing candidate; and
providing, by the processor, a final staffing candidate based on the at least one expected KPI.

20. The method of claim 19, wherein initial staffing candidate associates each resource among the plurality of resources with a single skill of a plurality of skills; and
wherein the multi-skill staffing candidate associates at least one resource among the plurality of resources with at least two skills of the plurality of skills.
